(19) United States
(12) Patent Application Publication
(10) Pub. No.: US 2025/0173760 A1
(43) Pub. Date: May 29, 2025

(54) SYSTEM AND METHOD FOR CONTROLLING AN ELECTRONIC DEVICE EMBEDDED IN A PACKAGE OF A CONSUMER PRODUCT

(71) Applicants: David Philip Miller, Zurich (CH); Michal Schwartz, Naharia (IL)

(72) Inventors: David Philip Miller, Zurich (CH); Michal Schwartz, Naharia (IL)

(21) Appl. No.: 19/041,232

(22) Filed: Jan. 30, 2025

Related U.S. Application Data
(63) Continuation of application No. 17/656,851, filed on Mar. 28, 2022.
Application No. 17/656,851 is a continuation-in-part of application No. 63/200,990, filed on Apr. 7, 2021.
Application No. 63/200,990 is a continuation of application No. 17/644,034, filed on Dec. 13, 2021, now abandoned.
Application No. 17/644,034 is a continuation of application No. 14/592,794, filed on Jan. 8, 2015, now Pat. No. 11,200,600.
Application No. 14/592,794 is a continuation of application No. 13/604,302, filed on Sep. 5, 2012, now abandoned.
(60) Provisional application No. 63/265,353, filed on Dec. 13, 2021.

(30) Foreign Application Priority Data
Sep. 6, 2011 (EP) 11405313.5

(51) Int. Cl. G06Q 30/0251; B65D 23/00; G06Q 30/02

(52) U.S. Cl. CPC G06Q 30/0261; B65D 23/00; G06Q 30/02; G06Q 30/0269

(57) ABSTRACT

Providing a state of desired effects (SDES) simultaneously on one or more presentation devices using a system having one or more switchers, each switcher having a unique identification code, activation parameters that control when the switcher is operable to send activation signals, and one or more triggers. Each trigger has a trigger identification code associated with a set of one or more presentation devices or associated with another switcher and another trigger, and triggering criteria relating to an occurrence of a particular event. One method includes activating a first switcher, receiving, at the activated first switcher, event information indicative of the occurrence of a particular event, determining if the event information meets triggering criteria for a trigger of the first switcher, and in response to the event information meeting triggering criteria for a trigger of the first switcher, activating the trigger of the first switcher that meets the triggering criteria.

### CROSS REFERENCE TO RELATED APPLICATIONS

This application is a continuation of U.S. patent application Ser. No. 17/656,851, filed Mar. 28, 2022, which is continuation-in-part application of U.S. patent application Ser. No. 17/644,034, filed Dec. 13, 2021, which is a continuation of U.S. patent application Ser. No. 14/592,794, filed Jan. 8, 2015, now U.S. Pat. No. 11,200,600, which is a continuation of U.S. patent application Ser. No. 13/604,302, filed Sep. 5, 2012. U.S. patent application Ser. No. 17/644,034 claims the benefit of U.S. Provisional 63/200,990, filed Apr. 7, 2021, and U.S. Provisional 63/265,353, filed Dec. 13, 2021. Application Ser. No. 13/604,302 claims priority benefit under 35 U.S.C. § 119 (a) to European Patent Application No. 11405313.5, filed on Sep. 6, 2011. Each of the above-listed disclosures is incorporated herein by reference in its entirety.

### BACKGROUND

### Field

The invention relates to a system and method for generating a database of data items indicative of synchronized actions. More specifically, this invention integrates and utilizes these actions with one or more electronic products to provide an immersive environment for users.

### Description of Related Technology

In a world of pervasive connected devices, connecting content for providing a common theme or message remains elusive. Drawing from filmmaking and interactive media, a collection of actions in a message dispersed among multiple devices over time can be likened to a storyboard (or a script). A storyboard in this context, may define actions, content, routines, outcomes that define a story according to a set of different actions to provide a unified presentation of a message.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages directed to presentation of synchronized actions on a plurality of APDs (APDs).

Embodiments described herein relate to systems and methods for providing a state of desired effects (SDES) simultaneously on one or more presentation devices in a system having one or more switchers, each switcher having a unique identification code, activation parameters that control when the switcher is operable to send activation signals, and one or more triggers, each trigger having a trigger identification code associated with a set of one or more presentation devices or associated with another switcher and another trigger, and triggering criteria relating to an occurrence of a particular event. Such methods can include activating a first switcher; receiving, at the activated first switcher, event information indicative of the occurrence of a particular event; determining if the event information meets triggering criteria for a trigger of the first switcher; in response to the event information meeting triggering criteria for a trigger of the first switcher, activating the trigger of the first switcher that meets the triggering criteria, wherein activating the trigger of the first switcher includes sending, by the first switcher, an SDES activation signal to a first set of presentation devices identified by the trigger identification code of the activated trigger, and providing by the first set of presentation devices a SDES based on the SDES activation signal, or sending, by the first switcher, a trigger activation signal to a second switcher identified by the trigger identification code, and activating a trigger of the second switcher if the activation parameters of the second switcher are met, wherein activating the trigger of the second switcher includes sending an SDES activation signal to a second set of presentation devices or sending a trigger activation signal to a third switcher. Such methods can be performed by one or more computer hardware processors configured to execute computer-executable instructions on one or more non-transitory computer storage mediums.

Various embodiments of methods for providing a state of desired effects (SDES) simultaneously on one or more presentation devices can include one or more other features. In some embodiments, activating the first switcher comprises determining that the activation parameters of the first switcher have been meet. In some embodiments, the first set of presentation devices includes one presentation device. In some embodiments, the first set of presentation devices includes a plurality of presentation devices. In some embodiments, the first set of presentation devices comprises one or more groups of presentation devices, and wherein each group has a common unique group identifier. In some embodiments, each of the one or more groups of presentation devices includes one or more presentation devices or one or more subgroups of presentation devices. In some embodiments, providing the SDES activation signal to a first set of presentation devices comprises providing the SDES activation signal simultaneously to a plurality of presentation devices. In some embodiments, providing the SDES activation signal to a first set of presentation devices comprises providing the SDES activation signal to a plurality of presentation devices non-simultaneously. In some embodiments, providing the SDES activation signal to a first set of presentation devices comprises providing the SDES activation signal to a plurality of presentation devices in a predetermined order. In some embodiments, the first set of presentation devices can include one or more of a television, radio, personal computer, video wall, smartphone, tablet computer, a billboard, wall display, an electronic display device, a mechanical robotic or display device, or product packaging. In some embodiments, the first set of presentation devices includes product packaging, and wherein the product packaging includes material coupled to a product for shipping the product. In some embodiments, the first set of presentation devices includes product packaging, and wherein the product packaging comprises material coupled to the product when the product is sold, or when the product is used. In some embodiments, the product packaging comprises material that covers part or the entire product. In some embodiments, the product packaging comprises material coupled to the product at any stage during production, storage, and delivery of product. In some embodiments, the product packaging comprises material used for holding, and transporting the product. In some embodiments, product packaging houses at least a portion of the product. In some embodiments, receiving event information comprise receiving event information from a computer system communicating information relating to an event. In some embodiments, the event is a sporting event, a political event, a promotional event, an environmental event, a particular date and time, a social event, an educational event, a gaming event, an entertainment event, a storyboard trigger event, or the event is a package initiated event. In some embodiments, the first switcher resides in non-transitory computer memory of a presentation device. In some embodiments, the first switcher resides in non-transitory computer memory of a server system.

Another innovation includes one or more non-transitory computer readable mediums for providing a state of desired effects (SDES) simultaneously on one or more presentation devices in a system having one or more switchers, each switcher having a unique identification code, activation parameters that control when the switcher is operable to send activation signals, and one or more triggers, each trigger having a trigger identification code associated with a set of one or more presentation devices or associated with another switcher and another trigger, and triggering criteria relating to an occurrence of a particular event, the one or more non-transitory computer readable mediums having program instructions for causing one or more hardware processors to perform a method of activating a first switcher; receiving, at the activated first switcher, event information indicative of the occurrence of a particular event; determining if the event information meets triggering criteria for a trigger of the first switcher; in response to the event information meeting triggering criteria for a trigger of the first switcher, activating the trigger of the first switcher that meets the triggering criteria, wherein activating the trigger of the first switcher includes sending, by the first switcher, an SDES activation signal to a first set of presentation devices identified by the trigger identification code of the activated trigger, and providing by the first set of presentation devices a SDES based on the SDES activation signal, or sending, by the first switcher, a trigger activation signal to a second switcher identified by the trigger identification code, and activating a trigger of the second switcher if the activation parameters of the second switcher are met, wherein activating the trigger of the second switcher includes sending an SDES activation signal to a second set of presentation devices or sending a trigger activation signal to a third switcher.

Embodiments described herein also relate to systems and methods for generating a database of data items indicative of synchronized actions. The database is dynamic in that the data therein (storyboard and other components) can be modified offline, online, and in real-time or near real-time. This enables presentation devices in or on packaging of a product, and/or presentation devices in the proximity of other presentation devices, to provide present a state of desired effects (SDES) to an observer in the proximity of the presentation device(s). The SDES can be generated using SDES information stored on the presentation device, and/or information received from another system. For example, SDES information received from another presentation device, a storyboard generation system, or another system. In some embodiments, a particular presentation device can present two or more different SDES. In an example, a presentation device can store SDES information that can be used to present two or more different states of desired effects on the presentation device. In another example, a presentation device can present one or more SDES using SDES information it receives from another presentation device or another system. In some embodiments, the SDES is presented based at least in part on other received, or sensed, information (e.g., environmental or geographic information, or vicinity information of other devices or system). In various embodiments, a switcher could activate a storyboard, switcher could activate a trigger in a storyboard, a switcher could activate a another switcher, a switcher could activate a trigger in another switcher, and/or a switcher could activate a SDES directly on a presentation device. In various embodiments, a storyboard could activate a switcher, a storyboard could activate a trigger in a switcher, a storyboard could activate a storyboard, and/or a storyboard could activate a trigger in a storyboard.

One innovation includes a system for providing a SDES on packaging of a product. The system can include a storyboard generation system having a communication circuit configured to communicate with a plurality of APDs, each APD incorporated in packaging of a consumer product. The storyboard generation system also includes one or more non-transitory computer storage mediums configured to store a plurality of SDES, each SDES including information of effects for one or more APDs, a plurality of event triggers, each event trigger being associated with event occurrence information, the event occurrence information indicative of the occurrence of an event, associations between each event trigger and at least one SDES, APD information including an identifier of each APD, and computer-executable instructions. The system further comprises one or more computer hardware processors in communication with the one or more non-transitory computer storage mediums, the one or more computer hardware processors configured to execute the computer-executable instructions to at least: receive event occurrence information, determine an event trigger based on the event occurrence information, determine a SDES associated with the event trigger; determine one or more APDs for communicating the SDES to using the presentation device information, and communicate the SDES to the determined one or more APDs. The system also includes a plurality of APDs, each APD incorporated in packaging of a consumer product, each APD including a communication circuit configured to receive the SDES from the storyboard generation system, a non-transitory storage medium configured to store a received SDES, and an electronic output element configured to communicate an output based on the received SDES, wherein the output includes at least one or an auditory output, a visual output, an electronic output, or a mechanical output.

Various embodiments can include fewer or additional features. In some embodiments, event occurrence information is communicated to the storyboard generation system from an information source other than a presentation device. In some embodiments, the information source comprises a website. In some embodiments, the information source comprises a computer system that provides a signal to the storyboard generation system. In some embodiments, at least one APD comprises a sensing circuit configured to sense the occurrence of an event and generate corresponding event occurrence information, and wherein the communication circuit of the at least one APD is further configured to communicate the event occurrence information to the storyboard generation system. In some embodiments, the at least one APD is configured to communicate the event occurrence information to at least one other APD. In some embodiments, the sensing circuit is configured to sense an audible event, determine a classification of the audible event, and generate the event occurrence information based on the classification of the audible event. In some embodiments, the sensing circuit is configured to sense a visual event, determine a classification of the visual event, and generate the event occurrence information based on the classification of the visual event.

In some embodiments of such systems, the communication circuit is configured to detect and receive an electronic signal and generate the event occurrence information based on a classification of the received electronic signal. In some embodiments, the communication circuit of each APD is configured to receive an electronic signal, and initiate communication of the output on the electronic output element based on the received electronic signal. In some embodiments, at least a portion of the plurality of APDs are associated with the same identifier. In some embodiments, the APD information includes a group identifier associated with at least a portion of the plurality of APDs. In some embodiments, each of the determined APDs have a common characteristic of the communication circuit. In some embodiments, the common characteristic relates to a display of the APD. In some embodiments, the common characteristic relates to a light emitting component of the APD. In some embodiments, the common characteristic relates to a sound emitting component of the APD. In some embodiments, the common characteristics relates to an electronic emitting component of the APD. In some embodiments, the common characteristic relates to a mechanical component of the APD.

In some embodiments, the at least one non-transitory storage medium is configured to store data associated with different environmental conditions, wherein the sensing circuit of the at least one APD is configured to sense a nearby environmental condition, determine a classification of the environmental condition, and generate environmental information based on the classification of the environmental condition, and wherein the electronic output element is further configured to communicate an output based on the received SDES and the environmental information. In some embodiments, the environmental condition is one of electronic waves, digital waves, magnetic waves, radiation, chemical properties, vibrations, heat, moisture, dryness, or an ambient light condition. In some embodiments, the communication circuit of the at least one presentation device is further configured to communicate a signal indicative of the environmental information to the storyboard generation system and to at least one APD. In some embodiments, the storyboard generation system resides on a server system, and the storyboard generation system communicates the SDES to one, or a plurality, of APDs via a wireless network. In some embodiments, the communication circuit of at least one APD is further configured to receive one or more data signals from another communication circuit of another APD attached to other packaging, the one or more data signals including indications of an identifier of the other APD, and to provide automation presentation information to the other APD based in part on the identifier of the other APD. In some embodiments, the communication circuit of at least one APD is further configured to receive one or more data signals from another communication circuit of another APD and to provide presentation information to the other APD via a wireless network. In some embodiments, the packaging comprises material that is coupled to the product during shipping. In some embodiments, the packaging comprises material that is coupled to the product when the product is sold and removed before the product is used. In some embodiments, the packaging comprises material that is coupled to the product when the product is sold and remains on the product. In some embodiments, the packaging comprises material that covers part, or all, of the product. In some embodiments, the packaging is coupled to the product at any stage during production, storage, delivery and usage of product. In some embodiments, the packaging comprises material that is used for holding, using and transporting the product. In some embodiments, the packaging houses at least a portion of the product.

In some embodiments, at least one of the APDs further comprises a communication circuit configured to communicate with other APDs; one or more non-transitory computer storage mediums configured to store a plurality of SDES, a plurality of event triggers, associations between each event trigger and at least one SDES, APD information, and computer-executable instructions; and one or more computer hardware processors in communication with the one or more non-transitory computer storage mediums, the one or more computer hardware processors configured to execute the computer-executable instructions to at least: receive event occurrence information, determine an event trigger based on the event occurrence information, determine a SDES associated with the event trigger; determine one or more APDs for communicating the SDES to using the presentation device information, and communicate the SDES to the determined one or more APDs. In some embodiments, the storyboard generation system is configured to generate a new SDES or modify an existing SDES after deployment of the APDs in packaging of products. In some embodiments, the storyboard generation system is further configured to store updated event triggers. In some embodiments, the event trigger is determined based on predefined signal sequences in the event occurrence information.

Another innovation includes a method for providing a state of desired effects (SDES) on packaging of a product. In some embodiments, the method includes storing, on one or more non-transitory computer storage mediums of a storyboard generation system, a plurality of SDES, each SDES including information of effects for one or more APDs, a plurality of event triggers, each event trigger being associated with event occurrence information, the event occurrence information indicative of the occurrence of an event, associations between each event trigger and at least one SDES, APD information including an identifier of each APD. The method can further include receiving event occurrence information at the storyboard generation system, determining an event trigger based on the event occurrence information, determining a SDES associated with the event trigger, determining one or more APDs for receiving the SDES using the presentation device information, and communicating the SDES to the determined one or more APDs, each APD incorporated in packaging of a consumer product. The method may be performed by one or more hardware processors executing instructions on a non-transitory computer readable medium.

Another innovation includes a non-transitory computer readable medium for providing a SDES on packaging of a product, the computer readable medium having executable instructions for causing a hardware processor to perform a method of storing, on one or more non-transitory computer storage mediums of a storyboard generation system, a one or more SDES including information of effects for one or more APDs, a plurality of event triggers, each event trigger being associated with event occurrence information, the event occurrence information indicative of the occurrence of an event, associations between each event trigger and at least one SDES, and APD information including an identifier of each APD. The method further includes receiving event occurrence information at the storyboard generation system, determining an event trigger based on the event occurrence information, determining a SDES associated with the event trigger, determining one or more APDs for receiving the SDES using the presentation device information, and communicating the SDES to the determined one or more APDs, each APD incorporated in packaging of a consumer product. The method can further include receiving the SDES at each of the determined one or more APDs, and providing an output based on the received SDES wherein the output includes at least one of an auditory output, a visual output, an electronic output, or a mechanical movement. The method can further include sensing the occurrence of an event at a computing device, generating corresponding event occurrence information, and communicating the event occurrence information to the storyboard generation system. In some embodiments, the computing device is an APD.

In one example, a storyboard may be created for putting together a presentation that may be presented to a consumer to promote a product. The storyboard may allow for helping to identify and separate the different actions or content that may be integrated together such that the final presentation may make use of different forms of actions and/or content to provide the unified presentation. To assist in generation of such a storyboard and for allowing for generation of a presentation based on the storyboard, a database of data items indicative of synchronized actions according to a storyboard will need to be generated and stored so that retrieval can be programmatically implemented at later times. In another application, dynamic storyboarding may occur, where the same package can be used for a variety of different themes and functionality. “Intelligent” packages can include an APD that is configured to receive information from the storyboard generation system and provide a state of desired effects (SDES), e.g., a presentation, based on the received information from the storyboard generation system. In some embodiments, an APD can provide a standard or default SDES based on receiving a local activation signal. In some embodiments, the APD can provide an SDES has been recently received from a storyboard generation system. For example, a SDES that has been received based on the occurrence of an event. In some embodiments, an APD communicates information relating to the occurrence of an event to the storyboard generation system, and in response, the storyboard generation system provides a SDES to one or more APDs. In some embodiments, an APD communicates information with other nearby devices (e.g., via Bluetooth or Wi-Fi) to receive information that can affect the provided SDES, or to communicate SDES information to another an APD.

In one embodiment, a consumer product packaging having an embedded electronic device is provided. The consumer product packaging includes a bottle configured to package a beverage. The consumer product packaging further comprises a memory, a receiver (for example, a signal receiver or a digital or chemical or other type of sensor), and a circuit. The memory may be configured to store an action to be performed in response to an input. The receiver (or a sensor, digital or chemical or other) may be configured to receive a physical input indicative of movement of the bottle. The circuit may be configured to retrieve the action stored in the memory upon receipt of the physical input and command an electronic communication module to perform the action. The circuit may be further configured to command the electronic communication module at a particular time or in a particular sequence based on receiving the physical input. The action comprises instructions to activate a light in the bottle. The electronic communication module is configured to perform the action based on the command received from the circuit. In some embodiments, a delay time is stored in the memory and corresponds to how long to wait before performing the action after receiving the physical input. The delay time may be any amount of time, for example, from zero seconds (where the action is performed immediately) to one or more seconds, or one or more minutes, or longer.

In another embodiment, an electronic device for providing a presentation is provided. The electronic device comprises a memory configured to store at least one data item. The at least one data item is indicative of at least one action to be output by the electronic device. The at least one data item is a portion of a storyboard, where the storyboard is indicative of the presentation to promote a consumer product, and where the electronic device output is communicated to an audience. The electronic device further includes packaging of the consumer product being promoted, the packaging having an electronic communication capability. The electronic device also includes an input module configured to receive input from another electronic device or a user of the consumer product and a controller. The controller is configured to retrieve the data item from the memory, where the retrieved data item includes time synchronization information to synchronize the action with the received input. The controller is further configured to control the electronic communication capability to take the action to communicate the presentation to the audience being in proximity to the electronic device.

In another embodiment, a method of controlling a presentation by an electronic device embedded in the packaging of a consumer product is provided. The method comprises storing at least one data item, the data item indicative of at least one action to be output by the electronic device. The data item is a portion of a storyboard, where the storyboard is indicative of a presentation to promote a consumer product, and where the electronic device output is communicated to an audience. The method further includes receiving an input from another electronic device or a user of the consumer product and retrieving the data item from a memory. The retrieved data item includes time synchronization information to synchronize the action with the received input. The method also comprises communicating the presentation to the audience via the packaging of the consumer product being promoted. Communicating the presentation comprises taking the action and wherein the audience is proximate to the consumer product.

### BRIEF DESCRIPTION OF THE DRAWINGS

FIG. 1 is a combined block and flow diagram showing an embodiment of an advertisement system according to exemplary embodiments of the invention;

FIG. 2 is a flow diagram showing an embodiment of an advertisement process according to exemplary embodiments of the invention;

FIGS. 3, 4, 5, and 6 show different applications of exemplary embodiments of the invention.

FIG. 7 is a functional block diagram of an exemplary system for generating a database of data items indicative of synchronized actions, in accordance with an exemplary embodiment of the invention.

FIG. 8 is a flowchart of an exemplary method of generating a database of data items indicative of synchronized actions, in accordance with an exemplary embodiment of the invention.

FIG. 9 is a flowchart of an exemplary method of retrieving data items indicative of synchronized actions from a database, in accordance with an exemplary embodiment of the invention.

FIG. 10 is a functional block diagram of another exemplary system of generating a database of data items indicative of synchronized actions, in accordance with an exemplary embodiment of the invention.

FIG. 11 is a functional block diagram of an exemplary system of retrieving data items indicative of synchronized actions, in accordance with an exemplary embodiment of the invention.

FIG. 12A shows an example of a hybrid advertisement process and application, according to some embodiments.

FIG. 12B shows an example platform 1200 (e.g., a cloud Areesa Media Platform 1200) that enables distribution of various electronic media to viewers.

FIG. 13 shows how the data repository may provide stored information to the storyboard module 1206 and/or the external data feeds and triggers module.

FIG. 14 provides another example flow of a trigger as processed by the platform and as it impacts the electronic devices.

FIG. 15 shows an example flow of integrating the platform with device manufacturing processes.

FIG. 16 shows an example flow of external data and triggers 1602 that are processed by the external data feeds and triggers module.

FIGS. 17-19 show examples of different products integrated with electronic devices and corresponding peripherals.

FIG. 20 shows how a user can configure an electronic device 2002 associated or integrated with a product.

FIG. 21 shows how multiple items of the same product 2102a-2102c can each display different media or message, for example as established at manufacture.

FIGS. 22A and 22B illustrate examples of systems that incorporate switchers, where FIG. 22A illustrates aspects of a general switcher system that can include one or more switchers, and FIG. 22B illustrates an example of a specific switcher system that includes multiple switchers.

The various features illustrated in the drawings may not be drawn to scale. Accordingly, the dimensions of the various features may be arbitrarily expanded or reduced for clarity. In addition, some of the drawings may not depict all the components of a given system, method or device. Finally, like reference numerals may be used to denote like features throughout the specification and figures.

### DETAILED DESCRIPTION

Various aspects of implementations within the scope of the appended claims are described below. The following description is presented to enable a person skilled in the relevant technology to make and use the invention. The aspects described herein may be implemented in a wide variety of forms and that any specific structure and/or function described herein is merely illustrative. Based on the present disclosure a person having ordinary skill in the art should appreciate that an aspect described herein may be implemented independently of any other aspects and that two or more of these aspects may be combined in various ways. For example, an apparatus may be implemented, and/or a method may be practiced, using any number of the aspects set forth herein. In addition, such an apparatus may be implemented, and/or such a method may be practiced, using other structure and/or functionality in addition to or other than one or more of the aspects set forth herein. Accordingly, any disclosed invention is not intended to be limited by the described implementations; instead, it is to be accorded with the widest scope consistent with the principles and features disclosed herein.

The word “exemplary” is used herein to mean “serving as an example, instance, or illustration.” Any implementation described herein as “exemplary” is not necessarily to be construed as preferred or advantageous over other implementations.

A storyboard generation system define actions, content, routines, and outcomes that tell story, to provide a unified presentation on one or more APD. Each APD can provide a state of desired effects (SDES), and the SDES from each APD collectively is a unified presentation. An APD is incorporated in packaging of a consumer product. An APD can include a communication circuit configured to receive the SDES from the storyboard generation system, a non-transitory storage medium configured to store a received SDES, and an electronic output element configured to communicate an output based on the received SDES, wherein the output includes at least one or an auditory output, a visual output, an electronic output, or a mechanical output.

APDs are becoming less expensive and smaller, and thus more easily integrated with various products and product packaging. Such devices can communicate a SDES to an audience. The “audience” can be one person or a plurality of people, for example, people in a certain vicinity (e.g., a room, a car, a classroom, restaurant, etc.), or in a larger venue (e.g., a gym, a stadium, a church, an arena, etc.). In some embodiments, two or more APDs communicate the SDES either individually or synchronously. The SDES may be part of a synchronized message or messaging campaign. The synchronized message may be an advertisement, for example, for the product with which the media device is integrated or for a similar or corresponding product, instructions, and the like. In some embodiments, a synchronized SDES may be a synchronized message provided across multiple mediums, for example, via visual and audio mediums and/or multiple devices. In some embodiments, the APDs providing the SDES can be connected via a centralized or cloud-based platform that manages the presentation, including communicating triggers, actions, and corresponding information to one or more devices to properly provide the presentation. In some embodiments, a platform can coordinate messaging between different devices based on various triggers, as described in further detail herein.

In some embodiments, a system or platform can be used to manage the synchronized message using a storyboard through an entire lifecycle of any product involved. In some instances, a product may be associated with packaging or a component that is integrated with an electronic device, for example a device capable of providing a message to a user. In some embodiments, the system or platform can integrate with equipment that manufactures the product or packaging for the product. For example, the system or platform can provide information from the storyboard (for example, details on triggers, actions, media/message data, and so forth) to the manufacturing equipment to program and/or initialize the corresponding electronic device from manufacture, which may save time and processing. The system or platform can then monitor the device and initialize the storyboard for the corresponding electronic device based on detected triggers, which may involve various signals, messages, and so forth. The system or platform can also update, modify, and/or integrate the electronic device and the corresponding storyboard and data anytime during the lifetime of the product and/or the electronic device. Thus, the product and its packaging can be updated with respect to messaging.

### Terms

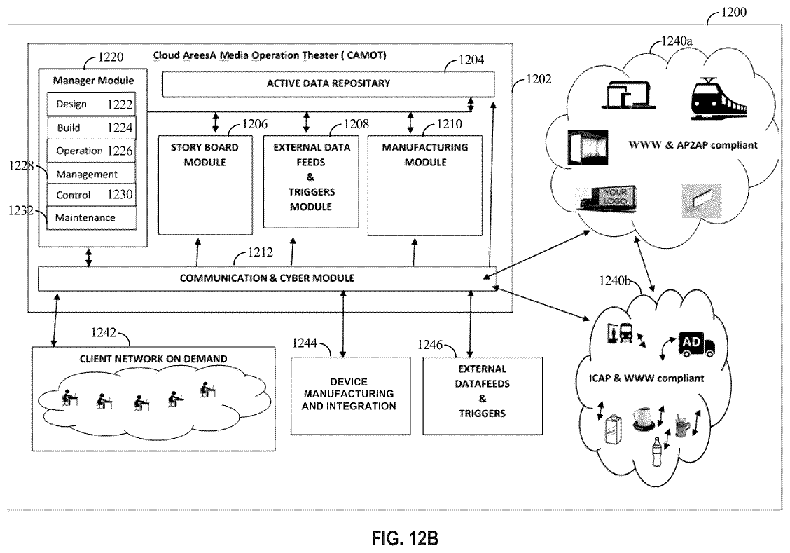

In order to facilitate an understanding of the systems and methods discussed herein, a number of terms are defined below. The terms defined below, as well as other terms used herein, should be construed to include the provided definitions, the ordinary and customary meaning of the terms, and/or any other implied meaning for the respective terms. In an example, the terms defined below refer to illustrative embodiments of a system illustrated in FIGS. 12-21. Thus, the definitions below do not limit the meaning of these terms, but only provide exemplary definitions.

Areesa Media Advertising Platform (AMAP): an example of a global adverting platform.

AreesA Media Sub Operating Systems (AMSOS): a system (software and/or hardware) in ICAPS, IDAPS, and AP2AP enabled AMAP components.

Advertising Platform to Advertising Platform (AP2AP): an advertising platform that can include propriety protocols and standards for communication, cyber security for data and information including architectures, formats, methodology, architecture, logic flow and operation.

Advertising Platform to Advertising Platform (AP2AP) Device: a device with optional WWW communication functionality.

Automation presentation device (APD): an automation presentation device is a broad phrase that refers to devices that may be incorporated in, or on, packaging of a product, that can receive information relating to a state of desired effects (SDES) from a storyboard generation system. For clarity and ease of reference, in some cases herein an automation presentation device is referred to as a “presentation device” or simply a “device.” Each automation presentation device provides a state of desired effects (SDES), and the collective SDES from each automation presentation device is the unified presentation.

Cloud AreesA Media Operation Theater (CAMOT): An example of a cloud-based global advertising platform.

Client Contract: a client contract defines the rights of a client relating to a switcher. Each client contract has a unique ID. The client contract defines the client's related to the setup and use of a specific switcher that is associated with the client contract ID. The client contract also can include pertinent client information, including financials, company personnel details, etc. that define the specific client rights within general set of rights of a specific switcher. Client contracts can be constructed in the External and Datafeeds & Triggers Module and stored in the Active Data Repository of the CAMOT (see, e.g., FIG. 12B).

Comm Gene: a component of AMAP communication.

External Data Feed: an external data feed refers to a communication connection between the CAMOT and systems/devices that are outside of the CAMOT. For example, presentation devices, virtual presentation devices, dedicated switcher devices, or compatible devices.

Event: An activity or event that can be used to activate a trigger for a switcher. Examples of events include, but are not limited to, a sporting event, a sales event, a sound, a sensed activity, a physical event, a virtual event, a gala, a news event, a security event, a social gathering, an emergency, a religious event, an online event, or a happening at a certain geographic location.

Intelligent Client Advertising Platform (ICAP): Any surface, object, or device including smartphone that can be used to provide a desired effect. For example, a screen, bottle, label, vehicle, billboard that are AP2AP compliant enabling a state of desired effects on packaging of a product.

Intelligent Design and Programming (IDAP): refers to the intelligent design and programming of hardware, firmware, software, logic, operating functionality (what, when, action) for interfacing with ICAP features and providing multimedia, robotics, and communication.

Presentation Device: a component, device or system that is capable of providing a visual or sound multimedia content, or a mechanical movement. Examples of presentation devices include, but are not limited to, televisions, radios, personal computers, video walls, smartphones, tablets, active billboards, displays (e.g., LED, LCD, mechanical) and the like.

State of Desired Effects (SDES): a presentation, or portion of a presentation (e.g., an effect or combination of effects), provided by a device or system (e.g., an APD). In an example, the SDES is a communication that can be perceived by a person (e.g., a sound or audio stream, a visual presentation on a display, one or more lights, a mechanical movement, and the like). In another example, the SDES is a communication that can be received by another device. For example, a radio communication signal. In another example, the SDES is an electronic emission of a sequence (e.g., a digital or analog sequence) which may be targeted to certain types of devices such that the sequence which would be targeted and recognizable by certain external devices other than presentation devices (for example, it would be recognized by a smart watch, a smart phone, or another mobile device. Accordingly, a “SDES” can refer to an electrical or electronic signal that can be received by a device. For example, a radio signal, a Bluetooth signal and the like. In various examples, the SDES can include one or more of a sound, a visual display, video, multi-media, one or more lights, a radio communication, or a mechanical movement. In an example, the mechanical movement is the opening and/or closing of a cover on a package. In another example, the mechanical movement is the expanding of a robotic arm or other structure from a package. In another example, the mechanical movement includes a rotational or swiveling movement of a platform on a package. In another example, the mechanical movement includes turning a wheel or another structure on a package. In another example, a mechanical movement includes a doll (or another structure or item) popping out of a package (e.g., shooting balls or confetti out of a package).

Storyboard Generation System: a system that can define actions, content, routines, and outcomes that define a story, according to a set of different actions, to provide a unified presentation of a message on one, or more than one, APD.

Switcher: a logical construct associated with a physical or virtual Event. For example, a Switcher can be associated with a basketball game or other sporting event, the holiday (for example, a religious holiday), a gala, a concert, the festival, a news event, a security event, or an emergency, and the like. The Event can have one or more of an associated date, time, or geographic location. In various embodiments, a switcher may reside in a presentation device, a virtual presentation device, a dedicated switcher device, another compatible device, or in the External Datafeeds & Triggers module (see for example, FIG. 12B). Switchers can be made in the CAMOT. Switchers can be stored in the Active Data Repository (see FIG. 12B). Once constructed, a Switcher can be downloaded to one or more of a presentation device, a virtual presentation device, a dedicated switcher device, or a compatible device. The control and operation of a switcher, including their activation, download and connectivity) is managed by the external data feeds & trigger module (FIG. 12B), which is the gateway for connectivity to and between switchers and storyboards stored in the Active Data Repository (see FIG. 12B). Devices (e.g., presentation devices, virtual presentation devices, dedicated switcher devices, and compatible devices) requiring connectivity to switchers and storyboards in the CAMOT Active Data Repository by devices can be connected via the External Datafeeds & Trigger module (see, for example, FIG. 12B).

A switcher can have an activation parameter indicative of its current state. For example, an activation parameter indicating the switcher is dormant, the switcher is available for use, or the switcher is unavailable for use. In various embodiment, when the activation parameter indicates the switcher is available for use, a trigger in the switcher can be activated (e.g., by receiving information that a particular event occurred) and the trigger provides a signal to a set of one or more presentation devices, or to another switcher, or to both. Users can define private switchers dedicated to their storyboards and presentation devices. Users can also share switchers, enabling permission and modification of rights to “trigger connect” triggers in switchers, storyboard and presentation devices. For example, the Federation Internationale de Football Association (FIFA) of the National Football Association (NFL) could setup switchers for its sports fixtures. These switchers could then be rented, or shared out, to other parties who could then “connect” the authorized triggers in these switchers to triggers of switchers, storyboards, and presentation devices in their (private, shared) pertinent systems. This also enables the collaboration of multiple entities in storyboards, presentation devices, in switchers, and their triggers enable endless combinations.

Switcher Activation Parameters: A switcher has parameters that define its use. For example, a switcher can have (i) a unique ID associated with an owner, (ii) its own unique ID, (iii) a group ID (switchers can be independent or belong to a group), (iv) activation parameters including, for example, its state (e.g., dormant, available for use, unavailable for use), user rights, duration rights (e.g., a date(s), times(s), geographic area, venue and other parameters that define its use. A switcher also has one or more triggers (described below) which may be fixed, or may be partly user modifiable. Authorization trigger rights are defined for a switcher when it is constructed. These authorization trigger rights will be accessible as per a client contract ID, which provides a client access to triggers for one or more switchers. The owner of a switcher can also be associated with the client contract ID of a client that has the rights to use the switcher.

Switcher User Rights: parameters that are associated with a switcher that control use of the switcher. For example, a parameter indicating that a certain user can use the switcher, the duration of use, one or more dates of use, one or more time of use, use in a geographic area, and/or use in (or for) a particular venue. Other parameters indicating limitations on use are also possible.

Trigger: A trigger is contained in a Switcher. Each Trigger is associated with a defined sensed action or occurrence of an event that activates the trigger, such that when the “triggering” action occurs, the trigger activates. The triggering actions are defined and presented or encoded in a format to be recognizable by the trigger. A trigger may also be “manually” activated, e.g., with a user input. Examples of such action include, but are not limited to, a mechanical action, an analog or digital action (signal), a communication, a physical action, a natural action, movement, sound, light, a sight (e.g., a sign, braille, sign language, etc.). In an example, a trigger is defined to activate based on a certain sound. If the certain sound is sensed and interpreted as being the defined sound, the certain sound becomes a triggering event for that trigger and the trigger activates. Triggers have parameters that can be set and modified by a person/system having the required authorization. Each trigger includes a unique identification (e.g., numbers, characters, and/or symbols). The ID can be indicative of data associated with the trigger and the switcher with which it is associated. each trigger can contain information (e.g., data and parameters) defining the trigger's response when it is activated. In one example, when a trigger is activated it can initiate communication, and communicate data, time dependencies, and one or more target ID's for receipt of the information related to the trigger. This information is contained in the switcher with trigger authorization rights and other authorization rights pertaining to target ID's for receipt of the information related to the trigger. Target ID's are associated with presentation device ID's as well as with corresponding trigger ID's. In some preferred implementations, the association information is stored in the External Data Fees and Triggers Module in the CAMOT (see, for example, FIG. 12B).

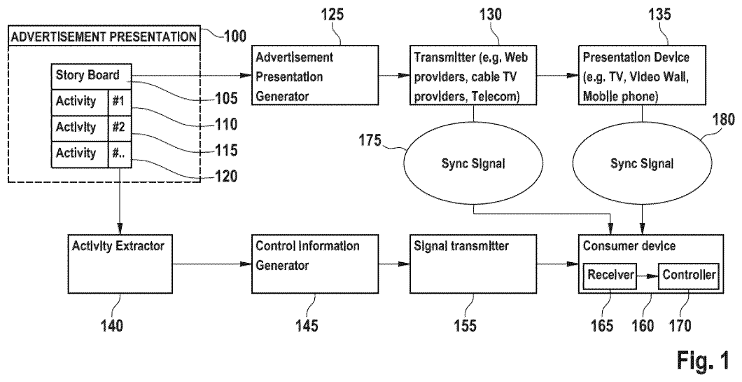

Referring now to FIG. 1, the system is configured to provide a message, e.g., an advertisement 100, based on a storyboard 105. The advertisement 100 can be a presentation of the message using devices generally described herein (e.g., by a plurality of ADPs). The storyboard 105, in addition to advertisement content like scenes, songs, etc., includes one or more activities, in the present embodiment ‘Activity #1’ 110, ‘Activity #2’ 115, and further activities ‘Activity # . . . ’ 120, which represent one or more actions by a consumer device. Although the storyboard 105 in FIG. 1 includes three activities, a storyboard can include any number of activities.

The storyboard 105 of the advertisement 100 is fed into an advertisement presentation generator 125 which generates a presentation signal or data set including these activities. Such analog or digital presentation signal or data set can be an advertising movie, a picture sequence or other multimedia event, an interactive game, or purely audio, and so forth.

The presentation signal or data set is then transferred to a content transmitter 130, e.g., a web provider, a software or web-based application, a platform, cable TV provider or the like, which transmits the presentation to a presentation device 135. The presentation device 135 can be a consumer or mobile device (e.g., a television set, a radio, a computer, a smartphone, tablet computer, a laptop computer, a portable media player, a home entertainment device, or a gaming device), or a public presentation device (e.g., a electronic billboard or digital electronic status board). The content transmitter 130 could be a cable TV provider, radio station or a Web provider (for example, application and/or platform). The content transmitter 130 may transmit content comprising detailed action data for the product, which may comprise packaging, a cover, and/or components thereof or a command to activate the packaging, etc., which then activates multimedia components of the packaging, etc.

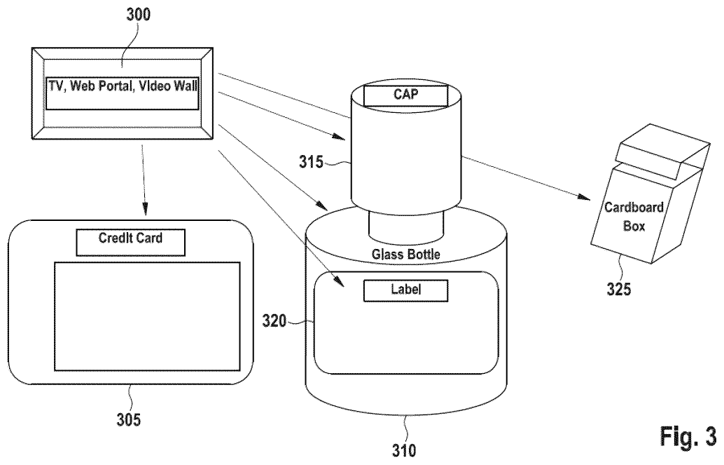

The storyboard 105 of the advertisement 100 is further fed into an intelligent activity extractor 140 which extracts the mentioned activities from the storyboard. Based on the extracted activity items, a control information generator 145 generates a signal including content and related control and/or functional (operational) data. The related control and/or functional data represents information about consumer device actions which are executed by a consumer device 160 and which correspond to the activities 110-120 included in the storyboard 105. Possible actions by the consumer device will be described in more detail in connection with FIGS. 3-5.

The content and related control data generated by the control information generator 145 is fed into a signal transmitter 155, which communicates the content and related control data to a consumer device 160. For this transmission purpose, the consumer device 160 includes a signal receiver 165 (or sensor) which feeds the received signal to an action controller 170. The action controller 170 can be part of the package itself, external to the package, or integrated or attached to the package, cover, or one or more components thereof. The action controller 170 can be any suitable device that causes the consumer device 160 to move, sound or react in any other way, corresponding to an underlying activity. However, if the consumer device 160 comprises a screen (LCD or OLED display or the like) and/or a loudspeaker, an optical device (e.g., spectacle), or projection (e.g., of a vacuum or air type, or a hologram), the action controller 170 may be optional as the received signal may be used to drive the screen and/or loudspeaker (or other audio device) directly without the need of previous conversion into an appropriate signal format.

In some embodiments, the content transmitter 130 and the signal transmitter 155 are separate components. In other embodiments, the content transmitter 130 and the signal transmitter can be integrated together as a single device.

Another aspect of exemplary embodiments of the invention is that the actions by the consumer device 160 are performed synchronously or in time with the presentation of the corresponding activities being presented on the presentation device 135 so that the mentioned immersion effect, i.e., the consumer device becomes an ‘immersion’ based part of the advertisement presentation, becomes valid. This synchronization is achieved, for example, using a synchronization signal which may be implemented by way of a ‘sync’ signal 175 transmitted by the content transmitter 130 to the consumer device 160 or by way of an alternative ‘sync’ signal 180 being transmitted by the presentation device 135 to the consumer device 160. However, it is possible to use multiple signals together such as the ‘sync’ signals 175 and 180, e.g., in order to improve the quality of synchronization. In addition, other signals may be transmitted to a source of the storyboard (e.g., the presentation device 135) resulting in an action that includes data transmitted to be stored in a database to trigger a storyboard directive.

The format of the ‘sync’ signal can be ‘Start/stop/action/time/period’, or any other suitable format including such information to be needed for the underlying synchronization.

It is worthwhile to mention that the second ‘sync’ signal can be implemented using the content of the presentation itself, either based on visible or hidden information like hidden video frames or hidden acoustic signals, so that in such case, a separate synchronization signal transmitter is not needed.

It is further noted that the two processes via the presentation device 135 and the consumer device 160 must not necessarily be executed or performed timely correlated or parallel in time. Further, the consumer device 160 may be a generic device with particular attributes assigned during its manufacture at its production time, including alterable or dynamic physical characteristics (e.g., chemical characteristics alterable via a reaction or electrical characteristics), built-in content and functionality and operation. These attributes can be activated or modified by the control information generator 145, by the presentation device 135, or by the signal transmitter 155 and/or the content transmitter 130.

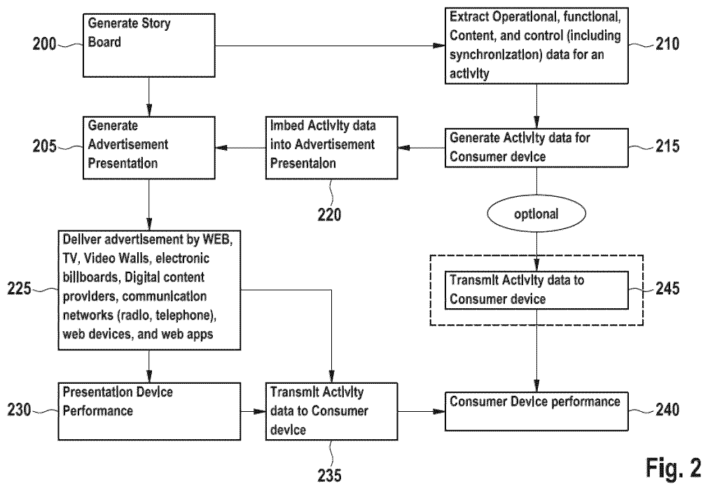

The advertisement process according to an embodiment of the invention is now described referring to FIG. 2. In a first step 200, a storyboard for a presentation is created or generated. The storyboard includes at least one previously described activity item.

Via a first branch of the overall process, in a second step 205, an advertisement presentation is generated based on the storyboard.

Via a second branch of the process, in step 210 content and related operational and functional data are extracted from the generated storyboard, including synchronization data for the activities. As already mentioned above, the second branch can be performed in parallel with the first branch, but not necessarily.

In a subsequent step 215, based on these extracted data, activity data, or an activity signal, for the consumer device are generated. In a final step 220 of the second branch, the generated activity data are embedded into the already generated advertisement presentation.

In a next step 225 of the overall process, the advertisement is delivered to the public, an individual, an enterprise, a retail establishment, as examples over the web (Internet), via dedicated web devices or web applications (or apps), e.g., using a digital content provider, or via one or more video walls, electronic billboards, or other communication networks like broadcast radio, television, satellite, GPS, or telephone networks.

The delivered advertisement then causes the presentation device to communicate a performance (step 230). In a subsequent step 235, activity data are transmitted to the consumer device, based on which the consumer device performs at least one action (step 240).

Alternatively, step 230 is optional which means that the advertisement is presented without a further performance. In such an embodiment, step 235 immediately follows step 225.

Also alternatively, instead of embedding the activity data into the advertisement presentation (step 220), the activity data generated in step 215 can be transmitted directly to the consumer device, according to optional step 245.

In various embodiments, the consumer device 160 can have attributes that are pre-assigned at manufacture time, including alterable or dynamic physical characteristics (e.g., chemical characteristics alterable via a reaction or electrical characteristics), built-in content and functionality and operation. These attributes can be set, reset, activated or modified by the advertisement delivery vehicle, by the presentation device 135, or by the control information generator 145.

FIG. 3 depicts an exemplary embodiment with specific devices in an advertising application of message deliver. In this embodiment, a presentation device 300 like a TV web portal or a video wall is enabled to send out the control information associated with a storyboard to a plurality of different consumer devices. In this example, the devices are a credit card 305, a bottle 310 including a consumable like a drink or a perfume, a cap 315 of the bottle 310, a label 320 of the bottle 310 and a cardboard box 325 e.g., of a cigarette pack.

These consumer devices 305-325 comprise native attributes, like the actual packaging material composed of glass or other materials, and one or more of the following other parts being attached to or embedded with the consumer devices, which provide multimedia functionality like an LCD screen, a sound system, a communication chip, a sensor chip, a processor and memory for executing software applications or “apps,” and/or physical attributes so that the devices may change inherent characteristics like color or shape.

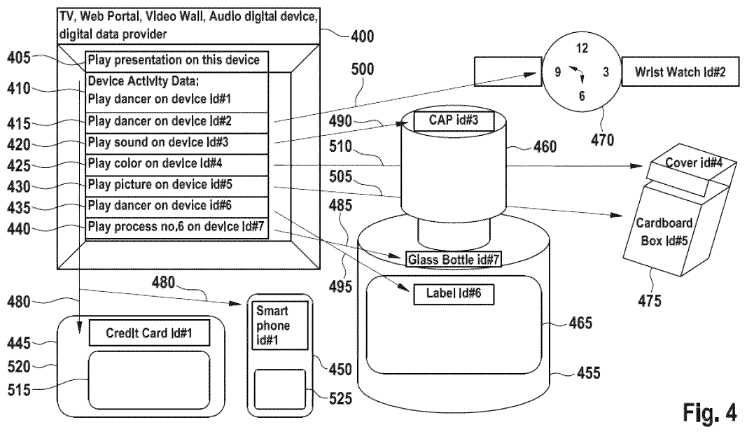

In the example illustrated in FIG. 4, the presentation device 400 may be a TV web portal, a video wall, a digital audio device, or a digital data provider. The presentation is illustrated as several entries or commands 405-440 of an underlying storyboard.

The first data item 405 is a command ‘Play presentation on this device’ which starts the presentation on the underlying presentation device 400. The other data items 410-440 correspond to different actions of an underlying consumer device, namely
‘Play dancer on device id #1’ (entry ‘410’)
‘Play dancer on device id #2’ (entry ‘415’)
‘Play sound on device id #3’ (entry ‘420’)
‘Play color on device id #4’ (entry ‘425’)
‘Play picture on device id #5’ (entry ‘430’)
‘Play dancer on device id #6’ (entry ‘435’)
‘Play process no. 6 on device id #7’ (entry ‘440’)

In this embodiment, the storyboard can be a complete production including audio and video events being played on all shown consumer devices 445-475 but being “orchestrated” by the presentation device 400, the corresponding underlying transmission channel 480-510 and the corresponding consumer device 445-475. In the latter example, one of the consumer devices 445-475 can control or determine the logic flow of the transmission channels 480-510 and the presentation device 400. However, there can be alternative examples where the production can be orchestrated by any of the participating consumer devices 445-475.

According to the timeline of the underlying storyboard, the entries 410-440 trigger the above seven actions (‘Play . . . on device . . . ’) on side of the respective consumer devices 445-475 synchronously with the underlying actions item included in the storyboard.

For instance, consumer device 445, a credit card which can be addressed by id #1 and thus is intended to play a dancer according to the first entry 410, plays the dancer on a flat screen 515 disposed on the credit card's front face 520. This flat screen can be, for example, an LCD, polymer panel or any other technology-based screen. A smartphone 450, having the same id #1, will play the dancer on its common touch screen 525 as well and at the same time.

As another example, a glass bottle 455 including the id #7 will play process no. 6 (according to above entry 440). This process, in the present embodiment, is pre-programmed in the consumer device, either at the time of its production or later. In the latter case the process is programmed prior to creation of the storyboard underlying the presentation.

The process no. 6 may include one or more sub-processes which can cause a change of the translucence of the bottle's material, e.g., from opaque to clear, or vice versa. Alternatively, the process or sub-process can be a flickering of one or more light emitting diodes or light reflectors being embedded in the glass. In such case, process no. 6 will be triggered and changes the bottle's material from opaque to clear. This change enables a storyboard to be presented on the consumer device wherein selected one or more pre-programmed processes can be addressed in the consumer device.

The bottle's cap 460 with id #3 plays a sound (entry 420) via a common sound chip being implemented in the cap. Further the bottle's label 465 which can be addressed via id #6 will play another dancer on a screen being implemented therein. The particular execution (e.g., contents, timing) of these different multimedia actions of the bottle 455 can happen synchronously with the underlying presentation on one or more presentation devices (e.g., for beverages or perfumes). In case of perfumes, these actions may help to support a “lifestyle” message of the underlying storyboard of the advertisement presentation.

As further examples shown in FIG. 4, a wristwatch 470 with id #2 may play a dancer on a small screen being arranged e.g., on its dial or face. A card box 475 may comprise two ids, namely id #4 for its cover and id #5 for the box itself. According to entry 425, the cover will change its color and the box, according to entry 430, will present a picture on a screen being arranged e.g., on the front face of the box.

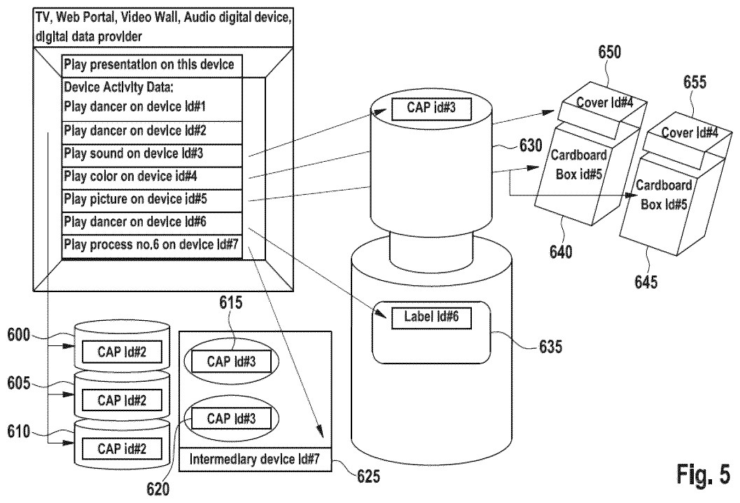

FIG. 5 shows another exemplary embodiment of devices which is based on the same storyboard as in FIG. 4, i.e., using the same entries 410-440. This example illustrates how actions of a plurality of consumer devices can be “orchestrated” to provide an above-mentioned collective action, i.e., an action being performed by a multitude of consumer devices in order to enable e.g., a matrix display effect.

FIG. 5 illustrates three bottle caps 600-610 that can be used to present a message that have the same id (id #2), and in this example play a dancer on a small screen being arranged preferably on top of each cap. Such a synchronous dancing event will multiply the effect, in particular, because this collective action is presented synchronously with a scene of the storyboard being presented on the presentation device.

Further two caps 615, 620 are arranged as part of an intermediary device 625 which can be a consumer device itself, or a separate control device. The intermediary device 625 can group the physically independent caps 615, 620 wherein process no. 6 on device id #7 would incorporate pertinent data for the caps 615, 620. This pertinent data can be sourced either from the presentation device, the service provider, or any other suitably associated programming device.

In addition, or alternatively, the intermediary device 625 can also be used for two other purposes: first to communicate with the presentation device and/or service providers mentioned above, and second to orchestrate these independent consumer devices 615, 620. If more than the two caps 615, 620 are used and controlled by the intermediary device, those caps can be arranged as a tray and thus be used to form a matrix structure allowing to build a complex display, and/or other functionality, wherein each cap represents a picture element (pixel) thus enabling to play pictures of movies of this matrix display. For this purpose, the underlying consumer devices may comprise built-in capabilities like (intelligent) communication logic or physical characteristics like chemical or physical properties, e.g., to enable a chemical reaction or magnetic feedback.

Still referring to FIG. 5, this example includes a bottle with a cap 630 and a label 635, in order to illustrate that a consumer device may include one or more individual components with assigned id # numbers which can be affected independently or be affected by interdependent processes. As an example, the bottle's cap can play a sound while a dancer is presented on the bottle's label. As another example, the dancer can be displayed as a collapsing person, if the cap has been programmed with a mono sound, or the underlying process being activated is that of a monotone beat. In still another example, the dancer can be displayed as dancing if the bottle's cap has been programmed with an up and down beat, or the underlying process being activated is an up and down beat.

Finally, the example in FIG. 5 includes two cardboard boxes 640, 645, each having the same id #5, and corresponding covers 650, 655, each having the same id #4. These boxes 640, 645 shall illustrate how similar consumer devices receiving the same activation control can result in different processes being activated in each consumer device.

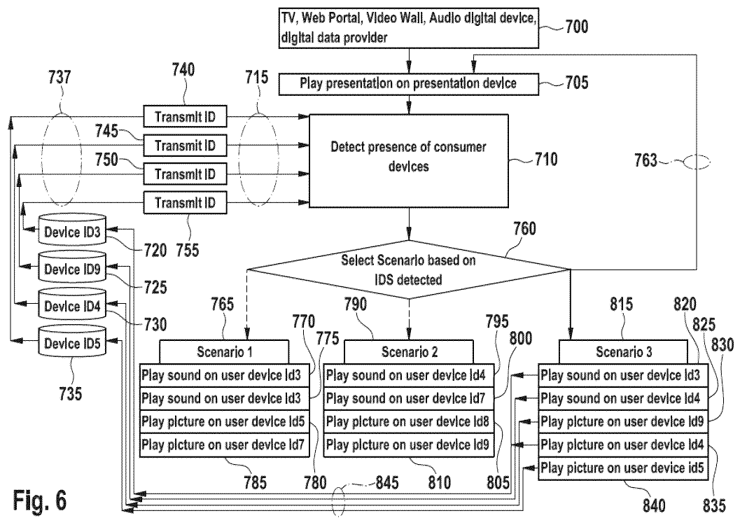

In the above description of FIG. 4 one or more of the consumer devices 445-475 can control or determine the logic flow of the transmission channels 480-510 and the presentation device 400. In order to further enhance this path of control, a back channel can be implemented for the transmission of underlying control information from the consumer device(s) to the action controller. This is illustrated in the following by way of embodiment, now referring to FIG. 6.

In the embodiment illustrated in FIG. 6, a storyboard is programmed with a story that can unfold and traverse different paths of action, thus activating different presentation scenarios (or scenes), and/or related command sequences, which are pertinent for the respective action by the consumer device. This enables to program storyboards based on dynamic sequences of alternative scenarios which can be selected and activated, dependent on the predetermined presence of one or more consumer devices. The underlying different actions to be executed by one or more consumer devices and the sequence of actions and underlying control commands communicated to a particular consumer device, as well as the underlying advertisement presentation to be presented on the presentation device, thus can be made dependent on the identified presence of recognized identifiable consumer devices.

As in the other embodiments, a content or data provider 700 initiates to play an advertisement presentation on a presentation device (step 705). In a different step 710, the presence of a consumer device, with an identifier IDS, is detected in order to select 760 a presentation scenario being adapted or being based on the detected consumer device. In the present embodiment, there are three different presentation scenarios 765, 790 and 815 available. ‘Scenario 1’ 765 comprises four activities 770-785, ‘Scenario 2’ 790 comprises four activities 795-810, and ‘Scenario 3’ 815 comprises five activities 820-840.

In addition, a selected presentation scenario 765, 790 or 815 is communicated to the presentation device via communication or control channel 763.

In the present example, by way of bold lines, it is assumed that ‘Scenario 3’ 815 is selected. The underlying activities 820-840 are communicated to consumer devices 720-735 via a further communication channel 845, wherein the consumer devices 720-735 will perform the underlying actions being defined in the transmitted activity items 820-840.

The above-mentioned detection of the presence of a consumer device is managed via a back channel 737, 745. In this embodiment, a particular consumer device is identified by its above-mentioned unique identifier (“IDS”) which is transmitted 740-755 to the presence detector 710.

The above-described embodiments enable advertisements to be customized in real time, i.e., the storyboard unfolds and runs its course according to the consumer devices being identified within the possible communication space (or “hot spot”) of the presentation device at the time of presentation.

These embodiments further enable advertising to be adapted and targeted to a status of a product. For instance, if an empty bottle of perfume would be detected within the possible communication space, then the advertisement presentation would play a presentation sequence including a message “to replenish” the product. If, on the other hand, a full or nearly full perfume bottle would be detected, the advertisement presentation would play a different sequence, e.g., including a “message of beauty”, in order to excite or stimulate the consumer to increase his or her consumption of the perfume.

In addition, these embodiments enable ‘shared brand’ advertising campaigns where, for example, the presence of a lemonade bottle and a cigarette pack would initiate a sequence with a message of “serenity”, whereas the presence of a bottle of whiskey and a cigarette pack would initiate a sequence with a message of “prosperity”.

Furthermore, these embodiments enable time information about consumer devices to be included in advertisement campaigns. For instance, consumer devices can be programmed with a physical date of its life span, so that in a case where a consumer device's life span is outdated, a sequence with a message “to update or purchase a new consumer device”, can be initiated. In the latter scenario, for a particular consumer device, the actual native status of the consumable is identified and is utilized as an active part of the underlying storyboard which is adapted to its presence and life span status of the consumer device.

In accordance with other embodiments of invention, a method and system can generate a database of data items indicative of synchronized actions according to a storyboard. In an embodiment, a storyboard is generated that involves actions or content performed by packaging of a product being promoted. A set of devices, including a device that is incorporated into packaging of a product being promoted, perform various actions in a coordinated fashion defined by a storyboard to provide a presentation. A storyboard generally defines multiple actions, content, routes, and outcomes that when integrated together form a unified presentation. Data items corresponding to the parts of the storyboard may be generated in response to determining the storyboard and stored in a database. The data items may include content (e.g., audio or video files) and time synchronization information for when a device is to perform a particular action. The data items are defined such that the involved set of devices may interpret the data items and act based on the data items to perform and/or display a set of interrelated actions and content that forms a unified storyline. Although each device may perform a small portion of the storyboard, the combination of the actions and/or content provided by each device provides an overall presentation. In addition, sub-storyboards may be provided for a device or a group of device that when synchronized provides an overarching storyboard that defines the presentation. As described above, the presentation may correspond to an advertisement. The actions or content may be coordinated according to synchronization data (e.g., time signals, etc. as described above) such that the storyboard may be played out in a coordinated fashion via the devices involved.

The storyboard may further be dynamic based on the types of devices involved or detected. For example, each device may have different capabilities for providing content. Upon detection of devices available via communication from those devices, a storyboard may be generated that utilizes capabilities of each of the devices detected. Actions defined as part of the storyboard may include communications between devices. For example, the devices may be able to signal their presence and in addition communicate with each other to provide signals for different outcomes or actions to trigger a subsequent action on another device or provide content to other devices. For example, in response to a device incorporated into packaging beginning to play an audio file, the packaging may communicate with another display device to initiate a video sequence that is synchronized with the audio file of the packaging which actions define a portion of the storyboard. After the storyboard is generated, the devices may receive information allowing them to play out the storyboard in a coordinated fashion.

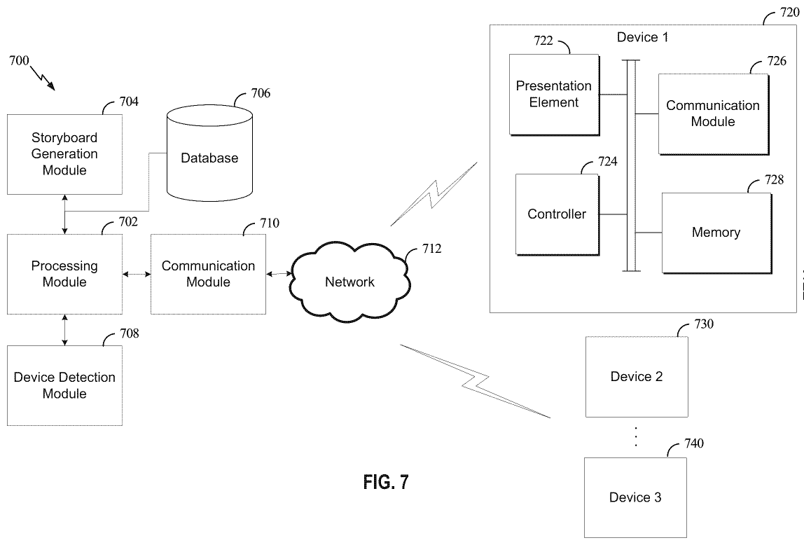

FIG. 7 is a functional block diagram of an exemplary system for generating a database of data items indicative of synchronized actions, in accordance with an exemplary embodiment of the invention. The system 700 may provide a presentation via multiple devices 720, 730, and 740. The devices 720, 730, 740 may be one or more presentation devices such as a video display or other device capable of providing multimedia content (e.g., televisions, radios, personal computers, video walls, smartphones, tablets, active billboards, and the like). At least one of the devices 720 is a product or is integrated with packaging or a housing of the product that is being advertised by the advertisement presentation.

A device 720 includes a controller 724 configured to control an action or delivery of content by the device 720. The device 720 further includes a presentation element 722 configured to provide content or other feedback to the user. For example, the presentation element 722 may be a display configured to display images or video. The presentation element 722 may be a speaker or other device configured to provide audio content. The presentation element 722 may be a light or string of LEDs. The presentation element 722 may dispense a portion of the product (e.g., dispense a sample of perfume or lotion). The presentation element may be any type of active element that is configured to provide some sort of action or content that may form a portion of a story as part of an overall storyboard of an advertisement presentation. For example, presentation element 722 may include an active or reactive material or have LEDs, LCD screen, speakers, servos, and the like. The presentation element 722 may be physically or communicatively coupled to the device or product packaging or may be part of the product packaging, a cover for the product, a similar device, or a component thereof.

The device 720 may further include a communication module 726. The communication module may be configured to receive information about an action and synchronization information for performing the action. The communication module 726 may be able to provide signaling to other devices to broadcast the presence/capabilities of the device 720 or to provide further synchronization information to other devices as described above via the “back channel.”

The device 720 may further include a memory 728. The memory 728 may be programmable and be further configured to store information relating to an action to perform or content to provide. The memory 728 may be configured to store content such as a multimedia file. The memory 728 may be configured to store time synchronization information relating to an action. The memory 728 may be configured to store a sub storyboard comprising a set of actions for performing by the device 720 via the presentation element 722. For example, a data item for a storyboard may provide information such that the controller 724 dynamically provides content based on detected conditions, outcomes, and capabilities of surrounding devices. This allows for adapting to dynamic storyboards that provide several different outcomes and or story lines based on detected conditions or feedback from the user.

As such, the device 720 may be provided to perform an action and/or to provide content that form a part of an overall story provided by a storyboard. The presentation element device 720 along with the communication module 726, the controller 724, and the memory 728 may be a part of or be a component within packaging of a product such as within a credit card, bottle, a cap, a label, a cardboard box as described above. The device 720 may be integrated with packaging or integrally formed as a portion of the packaging.

To generate and provide the storyboard, system 900 includes a processing module 704, a storyboard generation module 704, a communication module 710, a device detection module 708, and a storage device 706. It should be appreciated that the storyboard generation module 704 and the device detection module 708 may form part of or whose functions may be performed by the processing module 704. The device detection module 708 may be able to determine and/or detect a set of devices 720, 730, 740 for providing a presentation. The device detection module 708 may be configured to receive information from the devices 720, 730, and 740 via the communication module 710 via a network 712. The network 712 may comprise any type of network such as the Internet, a local area wireless network (WLAN), a cellular network, a fixed line communication network, satellite, and the like.

Based on information from the device detection module 708, the storyboard generation module 704 may generate a storyboard based on the types and capabilities defined by the device detection module 708. The storyboard may be defined by set of actions corresponding to stories, content, routes, and the like. The storyboard generation module 704 may generate the storyboard to allow for dynamic storylines that may be adapted in real time based on detected conditions such as a geographic location, consumer preferences, and preferred parameters such as religion, political, environmental, and social concerns as well as business dependencies and policies. The storyboard generation module 704 may generate data items corresponding to the set of actions/content. The data items may include time synchronization information for the set of actions of different devices 720, 730, and 740. The storyboard generation module 704 may receive user input to define one or more of the actions.

A data item that includes time synchronization information may comprise different types of information that indicate a time for performing an action. For example, the time synchronization information may be in the form of a time stamp such as an STMP time stamp. In addition, other offset time information may be included. Furthermore, information for how long to wait after another trigger message may be included, and the like.

The data items are collectively stored in a database 706. The database 706 may be implemented using relational databases, flat file systems, and/or other types of structured data storage systems that use storage devices (e.g., disk drives, solid state memories, etc.) to store data. Each illustrated database 706 may include multiple distinct databases, each of which stores a different data item. Furthermore, the database 706 is typically located on a server (not shown) and accessed via the network 712.

A processing module 702 may be provided that may coordinate the activities of the storyboard generation module 704, the device detection module 708, the database 706, and the communication module 710. The processing module 702 may receive data items from the storyboard generation module and provide them to the database 706 for storage. The processing module 702 may further receive user input for defining the storyboard and/or determining devices available. When a presentation is executed, the processing module may retrieve data items from the database 706 and provide them to the devices 720, 730, and 740 via the communication module 710. The processing module may take part in performing one or more of the actions such as transmitting time synchronization information according to the data items to help coordinate the performance of actions to play out the storyboard. In addition, the processing module may receive message from the devices 720, 730, and 740 to further trigger other actions. As such, in one aspect, the system 700 may allow for generating a storyboard for performing actions on a set of devices including packaging of a consumer product being promoted.

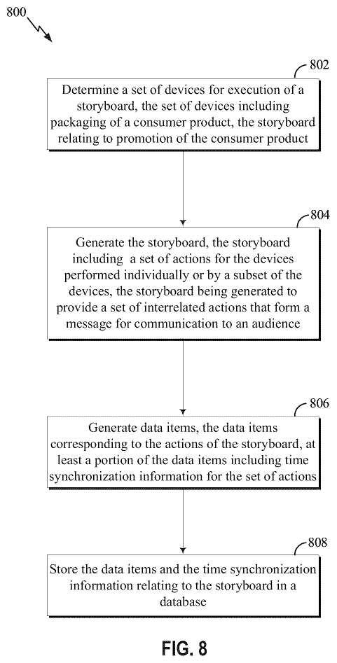

FIG. 8 is a flowchart of an exemplary method 800 of generating a database of data items indicative of synchronized actions, in accordance with an exemplary embodiment of the invention. At block 802, a set of devices are determined for execution of a storyboard. The set of devices includes packaging of a consumer product. In one application, the message defined by the storyboard relates to promotion of the consumer product. For example, the storyboard may relate to an advertisement presentation. The set of devices may include a variety of types of devices as described above. As one example, one of the devices may correspond to the device 720 shown in FIG. 7. The packaging may further comprise components, for example, as shown in the device 720 of FIG. 7 to provide an active element that provides feedback to a user for presentation within the storyboard. Determining the set of devices may include receiving communications from one or more devices indicating presence in a specific location or other information regarding device capabilities. In some examples, determining the set of devices may also include receiving user input to define the set of devices.

At block 804, a storyboard is generated. The storyboard includes a set of actions for the devices determined at block 802. The actions may be provided to be performed individually by a device or by a subset of the devices. The storyboard is generated to provide a set of interrelated actions that form a message for communication to an audience. The storyboard may include various stories, content, routes, and outcomes that may be further defined by the different actions. In addition, sub-storyboards may be defined for a particular device or group of devices of the set of devices that define actions that form the overall storyboard. The set of actions may define communications between two devices. In this way, further synchronization as described above between devices for performing various actions such as for indicating presence and for providing feedback between the devices to trigger various actions or provide additional content for presentation. In one aspect, generating the storyboard may include receiving user input to define various actions, content, stories, routes, outcomes, and the like. The storyboard may further be dynamic such that the set of actions defined by change or be configured to perform differently based on a detection of some condition. For example, the storyboard execution may be based on at least one of a geographic location, a received consumer preference (e.g., a user input), and a business purpose as described above. As such, in one aspect, generation of the storyboard may be done concurrently with playing out the storyboard such that set of actions are determined dynamically in real-time.

At block 806, data items are generated that correspond to the set of actions defined by the storyboard. At least a portion of the data items include time synchronization information for the set of actions. The time synchronization information includes a particular time or sequence in which an action is performed by a device. The data items may include content or pointers to content such as audio or video files or the like. At block 808, data items and the time synchronization information related to the storyboard is stored in a database. As described above, in one aspect, storing data items in the database for generation of the storyboard may be done, in some cases, as the storyboard is being executed by the one or more devices.

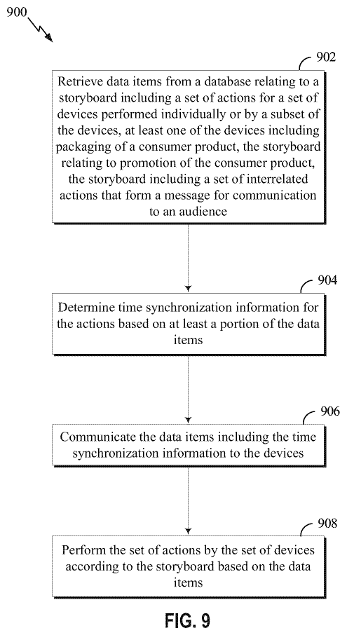

FIG. 9 is a flowchart of an exemplary method 900 of retrieving data items indicative of synchronized actions from a database, in accordance with an exemplary embodiment of the invention. At block 902 data items are retrieved from a database that relate to a storyboard including a set of actions for a set of devices performed individually or by a subset of the devices. At least one device of the set of devices includes packaging of a consumer product. The storyboard relates to promotion of the consumer product. The storyboard provides a set of interrelated actions the form a message for communication to an audience. For example, the storyboard may define an advertisement presentation. Retrieving data items from the database may include retrieving the data items based on detection of what devices are included in the set of devices and their capabilities. In this way, the storyboard may provide a dynamic mechanism to define actions based on detected devices. Furthermore, retrieving data items may be based on detected conditions, such as a particular geographic location such that the data items retrieved are dynamically chosen based on detected conditions as described above. In this aspect, the storyboard provides for data items for different geographic locations for dynamic generation of content/actions or based on user input or user presence detection.

At block 904, time synchronization information is determined for the set of actions based on at least a portion of the data items. For, example, a data item may define a specific time for performing an action defined by the storyboard. At block 906, data items including the time synchronization information may be communicated to the devices for execution. The information and data items may be stored in a programmable memory in a device such as the device 720 of FIG. 7. In this way, the data items may provide a programmable and dynamic set of actions that are performed by the device 720 based on detected conditions or based on signals from an external control module. In this aspect, the data items provided to a device or a group of devices may correspond to a sub-storyboard synchronized with the overall storyboard. At block 908, the set of actions are performed by the set of devices according to the storyboard. In one aspect, the devices may communicate with each other and a control module to provide different feedback and triggering mechanisms for coordinating the actions to provide the storyboard.

With reference to the methods and embodiments described above, it should be appreciated that in some embodiments, the progression of the storyboard provides for ongoing back and forth interaction between the database and the “performance of the storyboard” by the participating devices. This allows for external conditions to dynamically define how the storyboard is provided to present the message. For example, information relating to environmental attributes, geographical attributes, device presence detection, and human interaction may passively or actively impact the how the storyboard is defined to dynamically communicate the message to an audience. Accordingly, a variety of types of interactions may be incorporated into the storyboard including natural elements, physical elements, or virtual elements that might trigger a device action. For example, devices might be activated, re-positioned, or changed in any manner directly or indirectly via the storyboard. These interactions may be communicated and stored in a database for retrieval for different types of performances. The performances may be online, real-time, or delayed, for example, and therefore generation of the storyboard, including storage and retrieval of data items relating to the storyboard, may be ongoing and expanded during the storyboard performance.

In addition, a storyboard may allow for interactive communication with the devices. In one aspect, a user or any other living creature is also defined as a device in the context of a storyboard or data items may be generated that correspond to actions/feedback by and from a user. A user, for example, is part of the storyboard either by active interaction (for example by keyboard input), package or product or device positioning, physical movement, or passive interaction by mere presence.

In addition, defining a storyboard may further include integrating other storyboards, from other sources. For example, a storyboard may integrate customized storyboards defined by other services and product suppliers. These customized storyboards may include online or offline data orientated communication with devices defined in the customized storyboard. Integrated storyboard information can be used by all participating storyboards and stored for retrieval.

In one aspect, the storyboard provides a unique function whereby the storyboard becomes a virtual platform for presenting a message for promoting a service or consumer product. For example, a user may generate a product, service information, or other form of a service or product that is defined by a storyboard. Based on this storyboard, which may be based on rules and other data stored in a database or inherent in the storyboard actions, a user may extend or incorporate the storyboard into an active storyboard. For example, another company might promote another product or service that may provide a way to use or experience the product generated by the user. The company's product may further be defined by an active storyboard. The storyboard of the company's product can be extended to incorporate the storyboard of the user. As such, the user may be able to market their product in conjunction with the product of the company which also enhances the exposure and use of the product of the company. In other words, storyboards may be defined such that a storyboard defined by one entity may be integrated into a storyboard of another entity to allow for promoting services/products of both entities within a message. In this way, for example, storyboards defined for several distinct consumer products may be organized in a way such that they can be integrated into an overall storyboard that provides a message for promoting all the consumer products involved. In one aspect, each storyboard that is integrated may be referred to as a sub-storyboard.

It should be further appreciated that storyboards may be defined by games where devices, packaging materials or the materials objects themselves are game pieces. It should be further appreciated that storyboards may be defined so that they play out in a plurality geographical and physical and virtual locations with a plurality participating devices as described above. The message communicated via the storyboard may be dependent on a plurality of storyboards defined by geographical and virtual environments.

Furthermore, a storyboard may morph, extend, or connect different currently independent advertising platforms. For example, the passive packaging (label, wall, billboard, container, newspaper, magazine, and the like) of the product may be connected with an active transmitted advertisement (radio, TV, Internet, billboards) into one platform with complimentary/supplementary roles and interaction and actions that are dynamically managed by the storyboard.

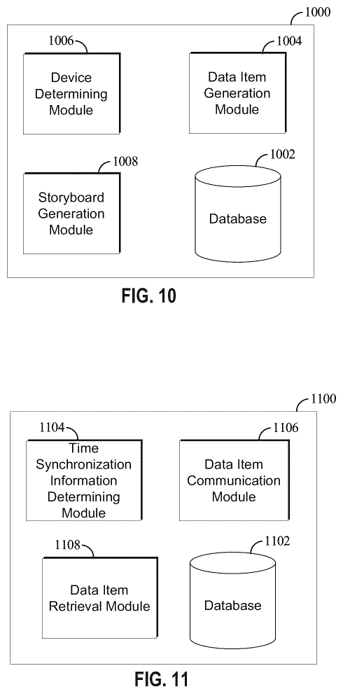

FIG. 10 is a functional block diagram of another exemplary system 1000 of generating a database 1002 of data items indicative of synchronized actions, in accordance with an exemplary embodiment of the invention. The generation system 1000 may include a device determining module 1006 configured to determine a set of devices for execution of a storyboard. The device determining module 1006 may be configured to perform one or more of the functions described above with respect to block 802 of FIG. 8. The set of devices includes packaging of a consumer product. The storyboard relates to promotion of the consumer product. They generation system 1000 may further include a storyboard generation module configured to generate the storyboard. The storyboard includes a set of actions for the set of devices which may be performed individually or by a subset of the devices. The storyboard is generated to provide a set of interrelated actions that form a message for communication to an audience. The storyboard generation module 1008 may be configured to perform one or more of the functions described above with respect to block 804 of FIG. 8. The generation system 1000 further includes a data item generation module 1004. The data item generation module 1008 may be configured to perform one or more of the functions described above with respect to block 806 of FIG. 8. At least a portion of the data items include time synchronization information for the set of actions. The generation system 1000 further includes a database 1002 configured to store the data items and information related to the storyboard. The database 1002 may be implemented using relational databases, flat file systems, and/or other types of storage systems that use storage devices (e.g., disk drives, solid state memories, etc.) to store data. The database 1002 may include multiple distinct databases, each of which stores a different data item.

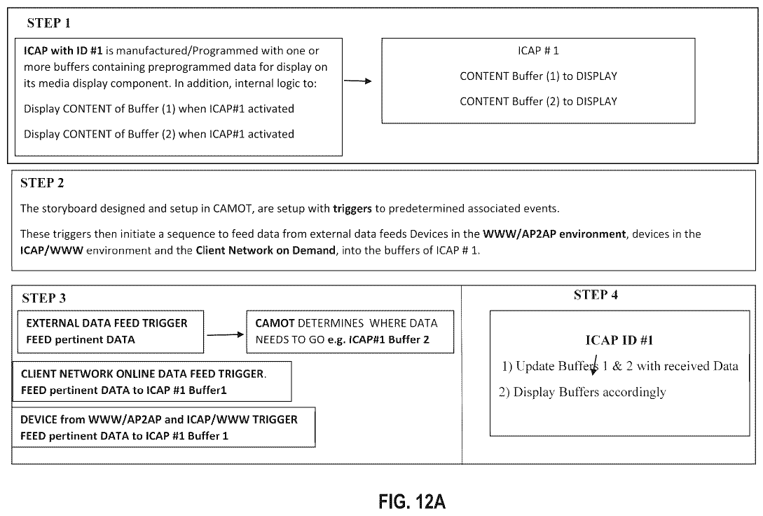

FIG. 11 is a functional block diagram of an exemplary system 1100 of retrieving data items indicative of synchronized actions, in accordance with an exemplary embodiment of the invention. The system 1100 includes a database 1102 configured to store data items that relate to a storyboard including a set of actions for a set of devices performed individually or by a subset of the devices. The database 1102 may be implemented using relational databases, flat file systems, and/or other types of storage systems that use storage devices (e.g., disk drives, solid state memories, etc.) to store data. The database 1102 may include multiple distinct databases, each of which stores a different data item. At least one device of the set of devices includes packaging of a consumer product, the storyboard relates to promotion of the consumer product. The storyboard provides a set of interrelated actions the form a unified story. For example, the storyboard may define an advertisement presentation. The system 1100 retrieves data items from the database 1102. This may correspond to one or more of the functions described with respect to block 902 of FIG. 9.

The retrieval system 1100 includes a time synchronization determining module 1104 configured to determine time synchronization information for the set of actions based on at least a portion of the data items. For, example, a data item may define a specific time for performing an action defined by the storyboard. The time synchronization determining module 1104 may be configured to perform one or more of the functions described at block 904 of FIG. 9. The retrieval system 900 may further include a data item communication module 1106 that is configured to communicate the data items to the set of devices. The data item communication module 1106 may perform one or more of the functions of block 906 of FIG. 9. A control module (not shown, but such as a processing module 702 of FIG. 7) may further coordinate actual playback of the storyboard on the set of devices.

Known advertisement systems using presentations, like movies, picture sequences or other multimedia content, which are presented on presentation devices, do not involve or immerse the consumer of an advertised consumer device so that the consumer and/or the consumer device do not become part of the advertisement or the underlying storyboard. For example, many use advertisement systems utilize single medium presentations (for example, a presentation on only one of a television, computer, audio source, mobile device, and the like).

To overcome these drawbacks, an advertisement system according to certain embodiments of the invention comprises a control information generator for generating first control information for at least one activity item of an advertisement presentation and a presentation device for presenting the advertisement presentation. The system further includes at least one consumer device which comprises a receiver for receiving the first control information and an action controller for controlling at least one action by the consumer device, based on the received first control information, wherein an action corresponds to a respective activity item of the advertisement presentation.

An advertisement system may include detection means for detecting the presence of a consumer device and selection means for selecting an advertisement presentation scenario based on at least one detected consumer device. The detection means may transmit information about the status of the at least one consumer device.

The presentation device may be a television set, a radio, a video wall, another device for broadcast audio and visual information, or a combination of such devices thus enabling more complex advertising events. The consumer device may be any apparatus or device which may perform an action, like electronic and/or mechanical devices, or the packaging of such devices, or of consumables like beverages, perfumes or cigarettes.

An action by the consumer device can be any visual or audible event, or combination of those, or a mechanical action or other effect that may be used to give the consumer the suggestion that he, and/or the consumer device, are an immersion-based part of the underlying storyboard of the presentation, or at least part of it. The proposed advertisement system thus has the advantage that a real action of the consumer device which corresponds to the underlying content or storyboard of the presentation helps the consumer and/or consumer device to become much more involved with the presentation thus increasing the advertising effect or efficiency.

In order to enable consumer device actions to happen synchronously, or at least nearly synchronously, with activity items of the underlying advertisement presentation, the first control information may include time information concerning the timing of an action of the consumer device in relation to the corresponding activity item. In particular, the start of an action of the consumer device may be triggered using this time information.

The advertisement system according to exemplary embodiments of the invention may further comprise a transmitter for transmitting the advertisement presentation to the presentation device and/or the first control information to the at least one consumer device. The transmitter preferably is a wireless transmitter and enables particularly the consumer device to communicate independent of its location, thus improving the inventive immersion effect. However, the transmitter can also be a wired connection, e.g., a power-line based transmission, an optical transmission line, or the like.

The action controller of the advertisement system may generate a time reference signal regarding the timing of the at least one activity within the advertisement presentation. The action controller then may transmit the time reference signal to the at least one consumer device so that the consumer device can act synchronously with the presentation storyboard.

The at least one consumer device may comprise a receiver for receiving the first control information or the time information and an actor for performing an action by the consumer device, controlled by the received first control information or the time information. In this embodiment, the actions of the consumer device can be started more autonomously thus increasing the immersion effect.

The advertisement system may further comprise a backchannel for transmitting second control information from the at least one consumer device to the action controller, in order to enable also interaction by the consumer with the advertisement presentation thus further increasing the immersion effect.

The backchannel thus enables advertisements to be customized in real time, e.g., by way of controlling a storyboard based on information being transmitted via the back channel to the action controller.

The backchannel can be further used to detect the presence of a consumer device and to select an advertisement presentation scenario (or scene) based on at least one detected consumer device thus enabling to select a scenario for the advertisement presentation which focuses on a consumer device being present on side of the consumer.

In addition, information about the status of one or more consumer devices can be transmitted using the backchannel in order to allow to select a given scenario which relates to such device status. The device status can be the charging or filling level of a consumable of the consumer device, e.g., a beverage bottle, perfume bottle or cigarette pack, or a consumer device's life span.

Exemplary embodiments of the invention also relate to a consumer device for performing an action based on an advertisement presentation, wherein the device comprises a receiver for receiving control information representing at least one activity item within the advertisement presentation. The control information includes time information concerning the timing of the at least one action within the advertisement presentation. The consumer device further includes an actor for performing an action by the consumer device which corresponds with the underlying activity, based on the received control information, wherein an action is triggered based on the time information included in the received control information.

Instead of, or in addition to, the consumer device, the packaging of the consumer device itself may perform an action. The packaging can be product label, or in case of a bottle, a bottle cap. Further examples of exemplary packaging or devices that may perform an action in conjunction with a storyboard as described above may be found in International Patent Application No. PCT/IL2009/000458 (Published as WO 2009/136391), entitled “METHOD AND SYSTEM PROVIDING A FUNCTIONAL ASSEMBLY OF ELEMENTS,” filed May 3, 2009, the disclosure of which is hereby incorporated by reference in its entirety.

As described herein, products packaged by product packaging may be consumable products. For example, the consumable product may be a food or beverage product (such as a fruit, soda, and so forth), a personal care product (such as shampoo, soap, toothpaste, and so forth), a home care product (for example, bleach, laundry detergent, and so forth), and the like. In some embodiments, the product packaging for the product is a bottle, a cardboard container, a cover, and the like, that holds or houses the product, as described herein.

In other embodiments the product is a reusable or single use product that is not consumed by the consumer, for example an accessory that can be used with the reusable or consumable product or in conjunction with another product or item of the product consumer or user. For example, the product accessory can be a sticker placed directly on the product, for example, a sticker on a piece of fruit, or the product packaging, for example, the bottle, box, bag, cover enclosure in which the product comes, or accessory of/for the product. In some embodiments, the product packaging or accessory is a holder or other component or device that enables, supplements, extends, or communicates, with the consumable product, for example, an ice cream stick, or straw in a bottle, gloves, and the like. For example, when the gloves are worn by the user, gloves may effectively become an extension of the product that the gloves are being worn to hold. For example, any message regarding the product being held by the glove may extend to the glove upon receiving a signal by sensors and/or inputs such that any message is integrated with the glove as well as any other component in the vicinity (for example, a mobile device of the user, a device integrated with the package, and so forth). For example, if the glove is used to hold a beverage, the glove may change colors to match advertising colors, images, etc., associated with the beverage. Such interactions could be maintained by the storyboards described herein. Similarly, an item that accompanies a product, for example, a free give away, may become an extension of or utilized as part of the package or device described herein.

In some embodiments, a corresponding product packaging or accessory may be separate from the product itself and include interactive or multimedia features. For example, the packaging or accessory is not actually part of the product. In some instances, the product packaging may be considered related to the product and may be considered or acted on together. In some embodiments, the product packaging or accessory (“product packaging”) is designed to have at least one feature or property that can be changed in a controlled manner to participate in advertising or messaging as described herein (for example, otherwise referred to as a smart, intelligent, reactive, or responsive material). One or more external signals or stimuli, such as electric or magnetic fields, light, temperature, and so forth, may cause the change in the at least one feature or property or a change in the messaging provided by the packaging.

In some embodiments, the at least one feature has at least one detectable characteristic, meaning that the feature is detectable by one or more senses of a person. The product packaging o may comprise or incorporate multimedia features that enable the product packaging to convey or participate in messaging. As such, the transmitted signals may cause the product packaging or accessory to react under various conditions (for example, in response to the external signals or stimuli or in response to a trigger), thereby enabling the packaging of the product to be used to convey a message (for example, an audible, visual, or other multimedia message) to or have meaning to a person viewing or using the product. In some embodiments, the product packaging may be used to enhance attraction to and/or use of the product and/or provide instructions that are related to the product, as described herein.

In some embodiments, the product packaging is one or more of a cover or housing of the consumer device, an electronic device, or any other device used by the consumer or user. The cover can be a case for the device. For example, a protective case or cover that houses, or fits around, part or all of the device (e.g., a smartphone case). In some embodiments, the cover is any object or component that partially or fully covers the device. Additionally, the product packaging may be a device or component that supports (for example, a device mount, coaster, stand, and so forth) or supplements the device (for example, an extension screen, keyboard, and so forth). For example, the product accessory may be a coaster, a container, a cup, a charging stand or platform, a warming plate or stand, or any similar device used in conjunction with the consumer product or device. In some embodiments, the product packaging itself includes the material that is sensitive to and/or reacts to transmitted signals.

As an example, the product packaging, may include cups, mugs, bags, insulated holders, and similar temporary packaging or containers. In an example, the product packaging includes items distributed to convey a state of desired effects (SDES). For example, a mug that provides a sound, changes color, or react in another way to release or reveal the SDES. In some embodiments, the SDES can be a sound clip, video clip, news clip, picture or graphic either imbedded in or communicated to the mug. The SDES may be identified and associated either directly with a secondary product or company by trademark or other symbol, color, symbol, or pattern on the mug. The packaging, via the corresponding multimedia or similar features described herein, may present an idea or a message to the audience. In an example, when the product is placed into any of these items, the item may identify features of the product to advertise, for example a product name, product commercial, product logo, and the like. For example, an item distributed to convey information or promote a person, company, product, and so forth, may make a sound, change color, display an image of video, or react in any way to reveal media content and, thus, operate as the packaging. In other words, the item may be interpreted by the platform and systems herein as the packaging when the item is used with the product even temporarily (for example, the mug containing the beverage). Thus, the package need only operate as a package for a period of time and need not contain or cover the product at any specific time. The media content may be embedded into or communicated via the packaging. Such media content may include an embedded trademark or other symbol or color or pattern or by association with the form/shape of the medium. Any of these products may have audio/visual presentation capabilities that provide messaging in a synchronized and coordinate manner according to the storyboard described herein, for example, in response to a relevant signal or new audio/visual message to be played out.

Additionally, the product packaging be integrated with the product. In some embodiments, the product provides the transmitted signals that cause changes in the at least one feature of the product packaging. In some embodiments, the system that generates the storyboard may provide signals for controlling a feature of the accessory, via one or more of the control information generator 145, the presentation device 135, the signal transmitter 155, and/or the content transmitter 130

In some embodiments, the smart, intelligent, or responsive material may be the accessory or packaging that allow the items to change one or more characteristics of the items (for example, color or shape). The smart, intelligent, or responsive material described herein may be a component in, a part of, or an entirety of a packaging or accessory for a product (consumable or otherwise) which covers any part of or all of the item or product, which may be a packaged item, a consumer item, an industrial item, and so forth. In some embodiments, the product packaging is an extension of the consumer product. The product packaging may sit on or be attached to the consumer product. For example, the product packaging may be a device cover, for example a phone cover, book cover, tablet cover, and so forth where the consumer product is the item being covered (e.g., the phone, book, tablet, and so forth, respectively). In some embodiments, the product packaging may be a part of, an extension of, or coupled to a housing of the consumer product or be any one or more of a suitcase, a luggage piece, a shoe box, a wallet cover, a passport cover, a desk cover, a table cover, a prospect cover, a paper cover, a folio cover, a light cover, an electronic appliance cover, a frame cover, a keyboard cover, and so forth. In some embodiments, the product packaging may be a cover of a product (for example, a suitcase cover or handle cover or cover for any other product) and may be integrated with electronic device components and operate as a medium for providing messaging. For example, the messaging may relate to instructions for depositing luggage, advertisements for an airline, luggage manufacturer, etc. Accordingly, in this example, the suitcase can be associated with travelling and the suitcase can be packaged in the cover, making the cover an active component in the storyboard, which promotes associated items or entities or provides related instructions by means of media presentations (for example, including audio visual messages, graphics, text, and corresponding information). In some embodiments, a cover or similar device can provide various helpful information, such as identifying ownership, travel information, and so forth. In another example, the product packaging could be a passport holder or travel wallet/pouch, which could cover travel items and be used to advertised random products and/or display pertinent information (for example, travel departure time, other flight information, and so forth), where such information is managed by the storyboard and the corresponding platform. As such, updates, for example travel times, gate changes for flights, etc., could be monitored by the platform or system and used as triggers to update information at the electronic product package as appropriate.

Similarly, the product packaging could be the cover of a prospectus and used for promotion. For example, for real-estate advertising of a realtor, where the cover displays real-time property availability and information. Similarly, a cover of a steering wheel could be used to promote automotive products or parts or vehicle manufacturers, etc. and provide real-time vehicle (or customizable) news. In any of these examples, the user may locally customize and/or control aspects of the storyboard and corresponding parameters or have the platform or storyboard system manage and control the storyboard parameters (for example, triggers, actions, messages, durations, time synchronization, and the like).

In some embodiments, as described above, the product packaging can be any device that surrounds, encases, covers, protects, holds, supports, and/or houses, partially or entirely, an item or product. The cover or packaging, which can incorporate one or more of a smart packaging material, electronic or other component that can participate in a multimedia presentation and/or can change inherent characteristics of itself or another coupled component or material. In some embodiments, the product packaging can extend a display of a consumer product, for example a TV, via a corresponding cover or extender.

According to another aspect of exemplary embodiments of the invention, consumer devices, or the packaging thereof, can be collected by the consumer thus enabling collective actions of these. For instance, a collective effect can be a pixel array to be composed of a multitude of bottle caps or labels.

Exemplary embodiments of the invention further relate to a method for immersive advertising based on at least one consumer device, wherein this method comprises the steps of preparing a storyboard which includes at least one activity, generating an advertisement presentation based on the storyboard, generating control or time information for the at least one activity within the advertisement presentation, providing the control or time information to the at least one consumer device, and performing an action by the consumer device, based on, or triggered by, the control or time information.

The storyboard may include at least two advertisement presentation scenarios and wherein the advertisement presentation is customized in real time using these scenarios, based on information being transmitted by the at least one consumer device. The presence of at least one consumer device may be detected and an advertisement presentation scenario is selected based on at least one detected consumer device. Information about the status of at least one consumer devices is transmitted and an advertisement presentation scenario is selected based on the transmitted consumer device status.

Current advertising systems may utilize multiple advertising mediums to convey advertisements but may not (and may not be able to) integrate messaging between the mediums. For example, advertising that occurs via television media may not be communicated with, integrated with, or synchronized with advertising that occurs via the Internet, radio, or cellular, and similar communications. There may not be direct interaction or communication with or between the products being promoted or identified in the advertisements or the devices presenting the advertisements. This lack of integration of advertisements and advertising devices may impede efforts to create immersive advertising and immersive advertising environments and create a problem for advertisers that wish to obtain maximum benefit out of an advertising campaign.

Advertisers may want advertisements to be memorable while avoiding provoking or agitating or annoying prospective target audience members. Currently, in the best of cases, advertisements may attract the audience's attention and be interesting to view, drawing the audience's focus. However, when the audience is exposed to many advertisements that are not tied to a single message, the advertisements may be interpreted as intrusions that interrupt the audience's concentration. The advertising systems and methods described herein may enable the target audience to take an action to stop or permit instances of being exposed to advertisements. In some instances, the target audience can customize messaging received to only relate to a particular item or brand or target audience group, and so forth. In some instances, the platform or system herein can include customizable features that enable customization of when or how messaging is presented. For example, when messaging on the packaging device is seasonal, the storyboard may automatically adjust what media to display based on a time of year or upcoming commercial holiday or change to a default media or message. Furthermore, when the advertisements relate to products, a lifetime of the product may often exceeds a lifetime of the advertisement or the advertising campaign. Thus, a single advertisement is often insufficient to last for the duration of the product's lifetime or even a product's packaging.

The systems and methods described herein provide exemplary solutions to some of the problems described above. The storyboard generation system generates a storyboard (for example, part of or encompassing an advertising campaign) to incorporate as many devices in the audience's environment as possible and provides a communications infrastructure to communicate with and between the APDs. The communications may use any available communication protocols that enable secure messaging between the storyboard generation system and one or more APDs. The system may provide a software component comprising instructions stored in a memory (for example, a non-transitory, computer readable medium) and executed by one or more hardware processors. The systems described herein may include one or more packaging, consumer, or user devices, as described herein, that communicate with the systems comprising the software component and/or hardware processors. These devices, in addition to the devices integrated with and/or comprising product packaging as described above, may include Internet of Things (IoT) devices. The communications between these devices and the system may be secured, as noted above.

According to another aspect of exemplary embodiments of the invention, the immersive advertising environment can be created by implementing the system as a cloud computing system and/or environment, wherein the generation and/or management of the storyboard is performed by the cloud computing system. The cloud system would communicate with and control conveyance of the storyboard actions, etc., to the number of networked devices connected to the cloud. Cloud, or network-based, computing, in general, is an approach to providing access to information technology resources through services where the hardware and/or software used to support those services is dynamically scalable to meet the needs of the services at any given time. In network-based services, elasticity refers to network-delivered computing resources that can be scaled up and down by a service provider to adapt to changing requirements of users. For example, the elasticity of these resources can be in terms of processing power, storage, bandwidth, and so forth. Elastic computing resources may be delivered automatically and on-demand, dynamically adapting to the changes in resource requirements on or within a given user's system. For example, the user can use the cloud, or network-based, service to host the immersive advertising environment, set up with elastic resources so that as devices and/or consumers receiving advertisements and the like from the immersive advertising environment increase, the number of webservers providing advertising content scale up and down to meet bandwidth requirements as system usage fluctuates.

Thus, the systems described herein are cloud or cloud-based systems and the devices participating in the immersive advertising environment each communicate with the cloud system via a wired or wireless connection. The cloud system may provide signals to these devices. The signals may include communications of actions to take, commands to trigger actions on devices, communications of information from other devices in the immersive advertising environment, and so forth. In some embodiments, the system may identify devices in the environment of a particular device or of a target audience member. In some embodiments, the target audience member may be exposed to or may have acquired a number of consumer devices, or the packaging thereof, thus enabling collective actions of these devices. For instance, a collective effect can be an array of screens or display elements composed of a multitude of bottle caps or labels, where the array of display elements is used to as a whole to convey a visual message to the target audience member. In some embodiments, the storyboard may be created and/or controlled in the cloud computing environment. When operating in the cloud computing environment, networked devices, for example, APDs (on product packages, products with housings, and the like) and computer devices (for example, cell phones, mobile computers, tablets, virtual and/or augmented reality devices, and televisions) participating in the cloud computing environment may be controlled according to a storyboard that is generated, and/or managed by, the cloud-based computing system. The cloud computing system may synchronize data between the cloud system and the devices, for example, capabilities, actions, status, and so forth, as described above as being communicated between devices.

The devices described herein (for example, the credit card, smart phone 450, bottle 455, box 475, watch 470, cap 460, and so forth) may communicate a myriad of attributes about the devices, including capabilities, communications, and so forth. In some embodiments, any part of the device can operate as an active component in the advertising campaign. The devices may use built-in or embedded components and/or the material of the packaging components itself. For example, as described above, some materials change properties (such as color, size, or any other attribute of the material) as part of a chemical, thermal, electrical, auditory, vibratory, or other reaction of the material with programmed controls or actions communicated by the systems, and such materials may be used to create a cover or other component for packaging of the device.

In some embodiments, the protocols and/or encryption used for communications between various components of the storyboard system or platform are customized and unique to the system or platform or part of a standardized encryption and/or protocol suite. In some embodiments, the system including the devices themselves may facilitate communications and advertisements through various mediums to create the immersive advertising system using a number of devices in the audience's environment. Where existing advertisement campaigns may include options for various communication mediums, they are unable to effectively and seamlessly integrate multiple mediums to create the immersive advertising experience capable from using the system described herein. For example, while current advertisement campaigns may identify advertisements for mobile advertisements and radio advertisements, such advertisements are not integrated such that a mobile advertisement triggers a radio advertisement or vice versa or where the advertising campaign can synchronize across multiple mediums to get a targeted advertisement while creating the immersive experience for the audience. Furthermore, such synchronization across mediums enables flow of advertisements using intelligent, communicative, multimedia components. The system can provide real-time and dynamic advertising that can extend lifetimes of the advertisement and/or storyboard, enabling advertising content and product lifetime synchronization. Additionally, the ability to update the product packaging ensure that the packaging does not become outdate for the product with which it is associated.

Additionally, the system described herein enables bi-directional information flow, whereby the various communication mediums (for example, mobile device, product packaging mediums, and the like) communicate between themselves and the cloud system. Such two-way communication may allow the devices operating over different mediums to collect consumer information from end users and convey it back to the cloud system, which may aggregate and/or otherwise track such information. The aggregated information may be used to generate a profile for the consumer and the system can generate targeted or specific advertisements and communications based on the profile. For example, perfume or cologne bottles may identify when a particular user tries one or more samples or handles one or more bottles and submit that information to the system. The system may then generate and control an advertising campaign designed for the profile for that particular user using advertisements for the perfume or cologne (or competing perfumes or colognes or other corresponding products of interest) until the particular user is determined to have purchased a perfume or cologne. The advertising campaign may include personalized advertisements to the particular user via mobile device, radio, television, and the like, where the mobile device can also integrate with the perfume or cologne bottle when in the store. Similarly, when the particular user already purchased the perfume, the perfume bottle may detect when it is nearly empty and inform the system of such event. Similarly, various products and product packaging in the user's home can communicate with each other and the system and update the user's profile accordingly. The system may then generate a personalized advertisement campaign across various mediums to encourage the purchase of the same or a competing perfume to replace the almost empty perfume. In some embodiments, the device may aggregate the information and generate the corresponding user profile. In some embodiments, the device or system may generate an audience profile, for example based on an exemplary audience to which device (for example, a multimedia advertisement board) is generally exposed. For example, the device for sale at or advertisement board available at a sporting event or mall may generate different profiles for the general audience at the sporting event or mall, i.e., different profiles for different locations for the device.

The system described herein may also enable online advertising and re-advertising over products and mediums. The system enables a medium for closing a gap in times of social distancing. The storyboard generation system (sometimes referred to herein as “system” for ease of reference) may enable messaging via the product packaging and associated devices provide educational messaging, for example, directed to environmental and/or health issues and the like. For example, a toothpaste packaging can play messaging (or communicate with a user's mobile device to play messaging) about turning off water while brushing or how long to brush for best effects. In some embodiments, particular messaging may be provided when the user uses the toothpaste with a particular brand of toothbrush or when the user brushes properly. In some embodiments, the product packaging devices can be used for message unrelated to the corresponding products. For example, during an emergency scenario, the storyboard system or platform could utilize devices within a specified or predetermined area to display messages regarding the emergency, for example, providing directions and information. The system may enable bidirectional messaging that can be used for trivia type activities, for example, setting up packages to play particular media or messages, present questions to a reader, and the like. The system and platform may enable the user to provide a response to the questions and enable ongoing, bidirectional communications by confirming or providing answers to the initial questions. In some instances, the system or platform may learn how to provide messages to particular users, identifying what mediums earn the best responses, and the like. Thus, future messages can be tailored to a particular medium or message type that was previously most successful or most helpful for that user. Such tailoring can be based on user location and interests, gender, age, and so forth. In some instances, the system or platform may know locations of products, which ads are or were being played, and so forth. This information may be gleaned from the database, the packages, users, and so forth by means of apps and controllers in the vicinity.

### Illustrative Embodiment

FIG. 12A shows an example of an embodiment of a hybrid advertisement process and application. FIG. 12B shows an example of an Areesa Media Advertising Platform (AMAP) that can perform the functionality described in reference to FIG. 12A. An AMAP is an intelligent real time global platform for advertising. Various embodiments can include the following characteristics of the advertising, and advertising campaigns performed by the AMAP: management, control, construction, simulation testing, communication, content update, action update, performance monitoring, feedback, storage, and data information flow from external platforms. In various embodiments, it is a cyber security platform utilizing a combination of customizing proprietary cyber security content, protocols and standards. For example, it can use proprietary protocols and standards (AP2AP) for communication and data/information security within the AMAP Environment. The participating client advertising platforms can be AP2AP compliant. The AMAP generates enables advertising with a hybrid of real-time content, online content, pre-programmed content providing a state of desired effects on packaging of a product. Real-time content can include automatic content from defined external data feeds and online AP2AP compliant data communication feeds. Preprogrammed content can be included on packaging to provide state of desired effects on packaging of a product.

In the example illustrated in FIG. 12B, the AMAP is implemented using “cloud” functionality, and thus the AMAP and the other systems and components it communicates with may be referred to as a Cloud Areesa Media Operation Theater (CAMOT) 1202. The CAMOT 1202 communicates a state SDES to one or more presentation devices, for example, any of electronic devices 1240a and/or 1240b. Online content can include preprogrammed content that is updated in a storyboard module 1206 residing in the CAMOT 1202. Some of the advantages of the CAMOT 1202 implementation include: (i) it enables real time and online content dated feed from external platforms; (ii) it generates and enables an advertising state of desired effects (SDES) or a “performance” with multiple ICAPs participating in a synchronized fashion; (iii) ICAPs are configured to be “intelligent” such that they are able to perform various actions based on a hybrid of preprogrammed capabilities and data, as well as real-time communicated information and data, (iv) capabilities include communication with other systems, robotics, and multimedia functionality; (v) facilitates two-way communication with participating; and (vi) production, control, maintenance of IDAP and their online role can be provided to ICAP manufactures, ICAP component manufactures, for their product production and integration. enabling a state of desired effects (SDES) on packaging of product—this allows remote programming and setup of production and manufacturing lines to install and integrate IDAP with ICAP products and components; (vii) allows virtual testing environment for advertising test runs, facilitating management, maintenance, and control of provided SDES; (viii) virtual environment mapping current real world scheduled and running advertisements real time online advertising, which facilitates additional management maintenance and control; (ix) virtual testing environment for IDAP product production lines, rollout, installations, and production, which further facilitates management, maintenance, and control over the entire process; and (x) virtual environment mapping current real world scheduled IDAP product production lines, rollout, installations and production, which also facilitates management, maintenance, and control over the entire process.

Referring to FIGS. 12A and 12B, in Step 1 an ICAP with ID #1 is provided with one or more non-transitory computer storage medium containing preprogrammed data for display on its media display component. The ICAP includes a hardware processor configured to execute instructions to display the preprogrammed data. For example, the processor is configured to execute executable instructions to: (i) display the content of buffer #1 when ICAP #1 is activated, and (ii) display the content of buffer #2 when ICAP #1 activated. In Step 2, the storyboard is designed and set-up in CAMOT 1202. The storyboard is associated with triggers (“event triggers”) that are associated with predetermined events. When the CAMOT 1202 has determined that in the event trigger has occurred, the system initiates a sequence to feed data into the buffers of ICAP #1. For example, the system can initiate a sequence to feed data from devices in a WWW/AP2AP environment (FIG. 12B) and/or devices in a ICAP/WWW environment (FIG. 12B) and the Client Network on Demand, into the buffers of ICAP #1. In Step 3, external data received by the system triggers communicating pertinent data to ICAP #1, and the CAMOT determines were data needs to go, for example, into ICAP #1 buffer #2. Also, another trigger, a client network online data feed trigger, can feed pertinent data to ICAP #1, for example, to ICAP #1 buffer #2. Also, another trigger, a device communicating via WWW/AP2AP network and/or ICAP/WWW, can feed pertinent data to ICAP #1, for example, ICAP #1 buffer #1. At Step 4, ICAP #1 receives data and updates buffers #1 and #2. The ICAP then displays buffer #1 and buffer #2 to provide the SDES to people (e.g., visual, audible SDES, and/or devices (e.g., signal SDES).

FIG. 12B illustrates a platform 1200 (sometimes referred to herein as the Cloud Areesa Media Platform or “CAMP” 1200) that enables a state of desired effects (SDES) to be communicated to one or more automation presentation devices (APDs) 1240a and/or 1240b, which may also be referred to as “electronic devices.” The platform 1200 includes software and hardware to provide a SDES to an APD for presentation to a user, based on one or more triggering events. In some embodiments, the APDs may be on or in packaging of one or more types of products. The various systems/components/devices of the platform 1200 illustrated in FIG. 12B (e.g., the operation theater 1202, the client network on demand 1242, the devices manufacturing and integration 1244, the external feeds and triggers 1246, the WWW & AP2AP compliant devices 1240A, and the ICAP and WWW compliant devices 1240B are in communication with one or more other systems/components/devices, and can be located apart from each other (e.g., in various geographic locations near or far apart). The APDs 1240 may provide the SDES based on a storyboard or plan as generated and/or coordinated by a server or controller, for example the operation theater 1202.

In some embodiments, the one or more APDs 1240 may be integrated with packaging of a product (e.g., a consumable product), or the one or more APDs 1240 may be integrated with another device that is associated with a product. For example, a bottle, a product or adhesive label, a part of a vehicle visible to the public as the vehicle moves along a road, a billboard, and the like. In an example, the APDs 1240 is on a vehicle that transports products (e.g., an outer wall of a truck), and such an APDs 1240 can receive information from a storyboard generation system to provide the SDES. In an example, the APDs 1240 is on a vehicle that transports products (e.g., an outer wall of a truck), and such an APDs 1240 can receive information from another APDs 1240 to provide the SDES. The APDs 1240 may comprise a screen capable of displaying text, video, and so forth and/or a speaker capable of playing audio. In some instances, the APDs 1240 may have connectivity to the Internet and/or a capability to community with other APDs 1240 that is, for example, in a vicinity or near an APD 1240. Such communications may be made using one or more proprietary protocols and/or standards for the communications, security, architecture, formats, methodologies, logic flows, operation, and the like. As referred to below, APDs 1240 may be part of, or in communication with, an intelligent communication platform 1200 coordinated by the operation theater 1202 that utilizes any surface, object, or device to convey a message to an audience, for example, creating an immersive environment for the audience. The electronic device 1240 may utilize customized hardware, firmware, software, logic, and the like to implement the integrated and/or immersive environment.

In some instances, the platform 1200 may be configured to provide one or more media files to the audience as part of a collection of messages, where the collection of messages assists in creating the immersive environment or enables interaction with the user via multiple mediums. In some instances, the platform 1200 may enable management, control, and/or testing of the media or messages, for example, as part of a storyboard or message plan. In some instances, the platform 1200 may enable communication between APDs 1240 involved in the messaging to the user (for example, the electronic device 1240 with which the user interfaces). The controlling operation theater 1202 may update content and/or actions for the APDs 1240, monitor performance of the platform 1200 and its components, media, and/or messages, monitor feedback from, for example, the APDs 1240, store media and/or messages, data on feedback and performance, and the like, and data and/or information from one or more external sources. The platform 1200 may further be utilized to coordinate messages on or via different media, for example via audio messaging separate from visual messaging in a coordinated, real-time manner. The messages may comprise pre-programmed content, dynamic content automatically generated based on information from one or more of the external sources and/or sensors, and/or on-line messages and may be updated dynamically in response to actions by the user or based on changes in the programming and/or desired messaging. The messaging can be directed to any subject, for example education of the user, introduction of ideas, products, items, and so forth. The platform 1200 may further enable synchronization between the media portrayed on different media channels (i.e., via different media) and by different APDs 1240.

In some instances, the platform 1200 may utilize the APDs 1240 that include interactive features for interfacing with the user and providing messages to the user with varying media methods or formats. In some embodiments, the APDs 1240 of the platform 1200 enables bi-directional communications with the user and other electronic devices for the user or other users. In some embodiments, the APDs 1240 can be programmed at production and/or manufacture with the media components and/or messages, and so forth. The platform 1200 may also provide virtual and/or testing environments through which different aspects and/or components of the platform 1200 can be tested, for example sending and/or receiving of test communications, messages, and/or synchronizations, with respect to management, maintenance, control, updates, and so forth. Thus, the platform 1200 can test messaging and/or media, integration with electronic devices, and the like.

In some instances, an example hybrid communication system and process may involve a first APD 1240a of the platform 1200 may be preprogrammed with data (for example, video and/or audio messages and the like) for conveyance to a user of the first APD 1240a. Furthermore, the first APD 1240a may comprise internal logic to display content in a first buffer location when the first APD 1240a is activated and to display content in a second buffer location when the first APD 1240a is activated.

The platform 1200 may utilize or implement a storyboard that includes one or more triggers for devices, for example, the first APD 1240a. The triggers may be used to initiate triggers to initiate a sequence of actions, for example feeding data from an external source or device to the first electronic device 1240a, conveying the message to the user via the first APD 1240a, feeding information from the first APD 1240a to the external source, and the link. In some instances, the trigger may cause the first APD 1240a to receive in the first and/or second buffer location the content in each of the first and second buffers. Then, when the trigger is received or triggered, the external source may feed the content to the first APD 1240a, for example, as determined according to the storyboard. The first APD 1240a may then update the first and second buffer locations based on the received content and the storyboard and then display the content to the user when activated according to the storyboard.

As illustrated in the example of FIG. 12B, platform 1200 comprises an operation theater 1202, which may embody the components, devices, and/or systems that enable the platform 1200 to communicate and/or share data and provide coordinated media to the user(s) of APDs 1240, for example according to the storyboards described herein. In some embodiments, the operation theater 1202 may operate as or comprise a server or controller device or system. The operation theater 1202 may comprise a data repository 1204, a storyboard module 1206, an external data feeds and triggers module 1208, a manufacturing module 1210, a communication and cyber module 1212, and a manager module 1220. The platform 1200 further comprises one or more compliant APDs 1240, an on demand client network 1242, a manufacturing and integration device 1244, and external data feeds and triggers, for example from an external source. Details regarding the different components of the platform 1200 are described below.

The storyboard module 1206, as described herein, may generate and/or manage a storyboard according to which the APDs 1240 convey a message to an audience. The storyboard module 1206 may generate and/or identify one or more storyboards associated with one or more of a particular user, electronic device 1240, products or items. Advertising platform to advertising platform (AP2AP) storyboards are logical structures. Group AP2AP enabled devices can activate and coordinate to provide SDES to tell a story, as defined in the storyboard, by directing content and commands to AP2AP enabled devices. The content and commands can include device activation, update of an event defined in a device, and activation of an event in a device. A storyboard contains events. When an event is activated it initiates it provides a storyboard action, or a portion of a storyboard. Each event may include:
Event ID #
Instructions
   Event
   Trigger
   Receiver AMAP component ID #
   Data

The Event ID # is a unique code associated with a specific event. An event can include multiple instructions. Each instruction includes an event description (e.g., one word description) and a trigger that is used to activate sending the data to the AP2AP devices with the AMAP component ID #'s. The trigger(s) associated activate when the associated triggering action occurs. Receiver AMAP component ID # identifies the target AP2AP devices that the data is communicated to.

An AP2AP device can be configured with a storyboard when the device is manufactured. An AP2AP device can also be updated, which updates its programmed storyboard. AP2AP triggers can be defined and setup in CAMOT 1202 and stored in the active data repository 1204. Triggers are associated with events and AMAP data feed/communication sources. Triggers are activated as defined by their event and AMAP association setup. AMAP data Feed/communication sources may include, for example, one or more of time, geographic position, time zones, and other defined parameters. AMAP data feed/communication source modes include, Auto, Realtime, and Online. The trigger actions may be immediately initiated by the occurrence of something, or the trigger action may wait to proceed after a delay, or the trigger action may proceed after an authorization is received.

The storyboards may comprise logical structures that include various information, including one or more media files or messages to be communicated. An example storyboard structure is provided below:

EXAMPLE STORYBOARD STRUCTURE

| | | | | | |
|---|---|---|---|---|---|
| 1 | Device # 1 | Event 1 | Trigger 1 | Event 2 | Trigger 2 |
| 2 | Device # 2 | Event 1 | Trigger 1 | Event 2 | Trigger 2 |
| 3 | Device # 3 | Event 1 | Trigger 1 | Event 2 | Trigger 2 |
| 4 | Device # 4 | Event 1 | Trigger 1 | Event 2 | Trigger 2 |
| 5 | Device # 5 | Event 1 | Trigger 1 | Event 2 | Trigger 2 |

The storyboard may be processed in a circular fashion from top to bottom, meaning that device #1 may perform the events in the corresponding row based on the corresponding triggers or according to a timing or synchronization schedule. For example, the storyboard may be arranged such that actions and/or triggers are arranged with earlier triggers and actions arranged above later triggers and actions. Thus, processing the storyboard sequentially from top to bottom would result in the time synchronization. For example, the events and triggers of device #1 may occur in time before the events and triggers of device #2, and so forth. Additionally, the trigger #1 will trigger the corresponding event #1, and so forth. In some instances, triggers can be tied to other or the same device. For example, trigger #1 for device #2 may be based on one of the events of device #1. In some instances, when the storyboard module 1206 analyzes defined triggers to identify corresponding actions or events, an event triggered by its pertinent trigger can result in the storyboard module 1206 sending a message defined by the event to the corresponding electronic device 1240 defined for that storyboard. Such analysis and messaging can also be performed by the manager module 1220 utilizing the communication module 1212. For example, during a televised sporting event, a scoring event may be a first trigger for a first event displayed on a mobile phone or beverage container (for example, “Score! Let's drink!”), while a break for commercials may be a second trigger for a second event, also displayed on the mobile phone (for example, “How about a pizza from Pizza Shop?”).

In some instances, the storyboards may identify one or more APDs 1240, as described herein, and coordinate activation of events for the one or more automation presentation devises 1240. Each event may comprise one or more actions for the corresponding APD 1240 to perform as part of the storyboard and for conveying a message to the user. The one or more actions may include activating the APD 1240, updating an event that the APD 1240 is configured to perform, activation of the original or updated event, and so forth. In some embodiments, the storyboard includes the events or actions for the APD 1240 to perform as well as information related to when or how the electronic device is to perform the event. Individual events may comprise one or more of an identifier and an instruction, where the instruction may comprise one or more of a trigger, an event or action to perform, an identifier for the APD 1240 that is performing the event or that is related to the event (for example, to which the event is directed or a target APD 1240, and so forth), and data associated with the event (for example, duration information, description, synchronization information, and the like). In some embodiments, the trigger of the event activates the associated event(s), which may initiate further storyboards, enabling one storyboard (i.e., sequence of actions) to trigger and/or comprise another storyboard. In some instances, the APDs 1240 are configured to update any stored storyboard information (for example, the event identifier or instruction information, the device identifier, and so forth. The APDs 1240 may receive updates to their programming from, for example, the storyboard module 1206 via the operation theater 1202. As described herein, the storyboards may determine and/or direct the functions for individual APDs 1240, which may be programmed according to the storyboard(s) at or after manufacture. The APDs 1240 may be reprogrammable after manufacture so that uses for the APDs 1240 can be changed after an initial use or adapted for different uses than originally programmed at manufacture. In some embodiments, the APDs 1240 may automatically respond to the storyboard or may require user interaction before performing actions according to the storyboard.

In some embodiments, the operation theater 1202 may define triggers for actions and/or triggers for APDs 1240. For example, the triggers for actions may be triggers that initiate a storyboard, while the triggers for the APDs 1240 may comprise triggers for the APDs 1240 to perform one or more actions according to the storyboard. In some instances, definitions of the triggers (for example, associations between monitored events and actions to perform in response to the monitored events) can be stored in the data repository 1204. In some instances, the data repository 1204 comprises any data storage device, for example, a database, a data store, and the like. The data repository 1204 may be configured to dynamically store and access data. The triggers stored in the data repository 1204 may associate events and data sources.

One or more external data fees 1246 may provide information to activate a trigger. In some examples, this information can include a time, geographic position, location information (for example, time zones), or other information to the CAMOT 1202. In some examples, the external feeds and triggers 1246 can include data feeds and communication sources, and such data feeds and communication sources can provide information automatically and constantly, in real-time or near real-time. The event triggers control actions of the APDs 1240 to initiate actions and/or interactions between APDs 1240. In some instances, triggers may cause APDs 1240 to proceed with providing a SDES, proceed with an SDES after a delay, or proceed with the SDES after authorization, for example, authorization by a user.

The manufacturing module 1210 may enable integrations with the manufacture of APDs 1240 and/or integration of the APDs 1240 with one or more other products. In some instances, the platform 1200 may integrate directly with components that program APDs 1240. For example, via such interactions, the platform 1200 may embed triggers, actions, and so forth in the APDs 1240 when they are manufactured and avoid needing subsequent programming steps. Accordingly, the platform 1200 may integrate with manufacturing equipment and processes of the APDs 1240. In some instances, the platform 1200 enables both online and offline, real-time and/or delayed control of various processes associated with the manufacture and/or development of the APDs 1240 and/or the devices or products with which the APDs 1240 are integrated. In some instances, the manufacturing module 1210 integrates with the manufacturing and/or integration equipment 1244 to allow the platform 1200 to directly program the APDs 1240 (for example, provide and integrate the storyboard and related features with the APDs 1240) and/or the products with which the APDs 1240 are integrated). For example, the manufacturing module 1210 may be configured to monitor and/or provide information (for example, storyboard information) during design production, setup, programming, and/or construction of any electronic device 1240 affiliated with the storyboard.

The external feeds and triggers module 1208 may enable the platform 1200 to work with triggers from external sources and/or sensors or triggers from APDs 1240 of the platform 1200. The external feeds and triggers module 1208 may enable the platform to respond, in real-time or delayed fashion, to the inputs received. The external feeds and triggers module 1208 may receive inputs and associate the received inputs with any trigger information stored in the data repository 1204. The external feeds and triggers module 1208 may, thus, identify when a trigger occurs and cause the platform 1200 (for example, one of the APDs 1240) to perform an action associated with the trigger based on the trigger information stored in the data repository and the received input.

In some embodiments, the inputs received and/or processed by the external feeds and triggers module 1208 may include signals and/or information that are commands to one or more components of the platform 1200 and content, for example, content for the APDs 1240. In some instances, the external feeds and triggers module 1208 may include details of triggers (for example, settings, parameters, and so forth) defined in the data repository 1204 and/or for the storyboards and the like. In some embodiments, the external feeds and triggers module 1208 receives external data that has an impact on one or more components of the platform 1200.

The triggers and external data processed by the external feeds and triggers module 1208 may allow for content to be selected and/or provided to the user of the electronic device 1240. For example, the platform 1200 could trigger a user's mobile device (as the electronic device 1240) to play a video showing a common use of a product based on detecting the user's proximity to the product or provide an instructional video for assembling a product based on detection that the product packaging has been opened (for example, sensors in the packaging or camera of the mobile device used to capture an image of the product packaging. Thus, the external feeds and triggers module 1208 may comprise one or more of alarms, signals, time, content update, changes in state (for example, open/close of packaging, etc.), activation of a content feed, receipt of a message, and so forth.

The communication module 1212 may enable communications between the components of the platform 1200, for example between the operation theater 1202 and the APDs 1240. In some embodiments, the communication module 1212 may enable the operation theater 1202 to work with encrypted communications. The communication module 1212 may control, regulate, and generally manage format, security, and other details of communications of the operation theater 1202 and the APDs 1240 within the platform 1200. The communication module 1212 may use standard, off-the-shelf or custom communication components and/or known or custom standards.

The manager module 1220 may operate as a controller of the operation theater 1202. In some embodiments, the manager module 1220 may manage operations and/or interactions of all components of the platform 1200. In some instances, the manager module 1220 may coordinate aspects of the storyboards, triggers, and actions of the APDs 1240 and interactions with the operation theater 1202. The manager module 1220 may control the design, build, operation, management, updating, and maintenance of the storyboards, triggers, actions, and the like.

The on demand client network 1242 may define and set up operation systems and content for APDs 1240 and the other components (for example, the manufacturing and integration device 1244 and/or external data feeds and triggers 1246). In some embodiments, the content and corresponding information can be stored in the data repository 1204. In some embodiments, the on demand client network 1242 may associate content and other information with identification and/or trigger information. For example, the on demand client network 1242 may store trigger information to broadcast or communicate to the manufacturing and integration device 1244 and/or the APDs 1240. The APDs 1240 and other components of the platform 1200 may be updated, reprogrammed, and/or modified, whether the devices and/or component are online and/or off line. Furthermore, the on demand client network 1242 may update, reprogram, and/or modify information of the components of the platform 1200, for example, details of operation of the components, construction, settings, and programming of the components, and so forth.

The APDs 1240 may include various devices and/or equipment, for example devices and/or equipment equipped with appropriate software (for example, web applications, application program interfaces (APIs), and the like). These devices may employ the protocols and/or standards of the platform 1200. These APDs 1240 may send and receive messages between CAMP and the environment in which the electronic devices exist and between different environments. In some instances, the APDs 1240 can be stand-alone devices or integrated into other devices, for example, digital billboards, vehicles, signs, and so forth.

In one example, the platform 1200 setup would incorporate the following information regarding defining events that activate triggers, and the actions that are caused to happen as a result of the trigger being activated.

TELEVISED FOOTBALL MATCH DATA CONTROLLED
TABLE, FED BY EXTERNAL FEEDS.

| | | | | |
|---|---|---|---|---|
| TRIGGER # 1 | Trigger Goal Scored | Scorer | Team | Team scored |
| | | | Scored | against |
| TRIGGER # 2 | Trigger AD Time | | | |
| TRIGGER # 3 | Trigger AD Time | | | |
| TRIGGER # 4 | Trigger Game Over | Score | Winner | Loser |

TELEVISED FOOTBALL MATCH STORY BOARD, TRIGGERS ACTIVATED
BY FOOTBALL MATCH DATA CONTROLLED TABLE

| | | | | | | | | | |
|---|---|---|---|---|---|---|---|---|---|
| 1 | AP2AP | Event 1 | Trigger 1 | Event 2 | Trigger 2 | Event 3 | Trigger 3 | Event 4 | Trigger 4 |
| | Device# 1 | Change Bottle | | | | | | | |
| | | colors to color of | | | | | | | |
| | | Team scoring. | | | | | | | |
| 2 | AP2AP | Event 1 | Trigger 1 | Event 2 | Trigger 2 | Event 3 | Trigger 3 | Event 4 | Trigger 4 |
| | Device# 2 | Animate Player | | | | | | | |
| | | On Label | | | | | | | |
| 3 | AP2AP | Event 1 | Trigger 1 | Event 2 | Trigger 2 | Event 3 | Trigger 3 | Event 4 | Trigger 4 |
| | Device# 1 | Play 5 music | | | | | | | |
| | | notes | | | | | | | |
| 4 | AP2AP | Event 1 | Trigger 1 | Event 2 | Trigger 2 | Event 3 | Trigger 3 | Event 4 | Trigger 4 |
| | Device# 3 | | | | | Animate | | | |
| | | | | | | label | | | |
| 5 | AP2AP | Event 1 | Trigger 1 | Event 2 | Trigger 2 | Event 3 | Trigger 3 | Display Score | Trigger 4 |
| | Device# 4 | | | Display | | | | & Flash | |
| | | | | “coke is | | | | winning team | |
| | | | | it” | | | | colors | |

The platform 1200 communicates directly with ICAPS in the ICAP & WWW environment as well as with Devices in the WWW & AP2AP.

ICAPS in the ICAP & WWW environment can communicate with devices in the WWW & AP2AP environment

### Example (2) of a Story Board

Storyboards defined in the platform 1200 can be incorporated directly into advertising and marketing, for example, into a presentation of audio visual clips and digital audio.

Triggers in this example may be:
time values indicating run time from the beginning of the audio visual clip or digital audio.
Fix points programmed into “audio visual clips and digital audio.”
Sequence.

These triggers would then activate storyboards associated with these audio visual clip or digital audio.

The association and access to the Storyboards defined and built in the platform 1200 can be accomplished by AP2AP standards and protocols and imbedded into the audio visual clip or digital audio sequences.

Storyboards could be constructed from Sub Story boards.

### Example

### “AUDIO VISUAL CLIPS AND DIGITAL AUDIO.”

### SEQUENCES

SEQUENCE COKE AD FIFA 2000

| | | | | | |
|---|---|---|---|---|---|
| SEQUENCE COKE AD FIFA 2000 | AUDIO | Trigger #1 | AUDIO | Trigger #2 | AUDIO |
| | VISUAL | | VISUAL | | VISUAL |

SEQUENCE COKE AD FIFA 2000 STORY BOARD

| | | | | |
|---|---|---|---|---|
| SEQUENCE COKE AD FIFA 2000 | Trigger #1 | STORYBOARD | Trigger #2 | STORYBOARD |
| | | Coke Display | | Coke “PLAY |
| | | “Cheers” | | SOUND” |

In some instances, the APDs 1240 may be integrated with surfaces or devices that can be used to convey messages to an audience. For example, the APDs 1240 may comprise devices that can communicate via the Internet or a network, such as smartphones, vehicles, computers, storage devices, and the like. The APDs 1240 may comprise or be integrated with packaging, containers, and/or enclosures and corresponding peripheral and/or accessories. The packaging may include wrappings, boxes, bottles, cans, and the like, while the containers may include receptacles, vessels, holders, repositories, canisters, drums, boxes, cases, and the like. Enclosures may comprise any structure that encloses a space, such as a body of a vehicle, the walls of a shelter, billboard structures, advertising walls, covers, and the like. These APDs 1240 may be intelligent and reactive (responsive) to inputs and/or triggers. The APDs 1240 may be programmed and setup (with respect to the storyboard) during manufacture, as described above. Similarly, any data associated with the APDs 1240 (for example, trigger information, action information, media information, and the like) can be identified and loaded to a memory of the APDs 1240 at manufacture or updated and loaded into the memory of the APDs 1240 after manufacture, as described herein. The APDs 1240 can be loaded at manufacture or after manufacture with identification information, communication standards and protocols, operational software and/or hardware, storyboard information, media information, and the like to enable the APDs 1240 to participate in an associated storyboard. In some embodiments, the manufacture of the electronic device 1240 or the product with which the electronic device 1240 is integrated includes or is constructed with an active material and/or substance that can change state in response to a signal or trigger. For example, as described above, the active material can change characteristics such as texture, color, shape, finish, audio, and the like. The active material may involve a reaction to a stimulus or activation of a process, such as a chemical reaction, thermal changes, responses to audio and/or visual stimuli, and the like. In some instances the electronic device 1240 may receive power from one or more sources, including battery, solar, hardwired, wireless, and similar sources. As noted above, the APDs 1240 may exchange communications with the other APDs 1240 and components of the platform 1200 using the standards and protocols as described herein.

In some instances, the APDs 1240 comprise peripherals for other devices, for example as communication devices, charging devices, functional devices, and the like. These peripheral devices may comprise integrated characteristics, including multimedia, robotic, operational, and logic capabilities at manufacture time. In some instances, the APDs 1240 have functionality to monitor themselves, for example location information of the electronic device 1240, awareness of other APDs 1240, identity information for other APDs 1240, recognition of information being communicated by other APDs 1240, and so forth. For example, one of the APDs 1240 can recognize and identify APDs 1240 that communicate with it and can discern between different devices communicating with it.

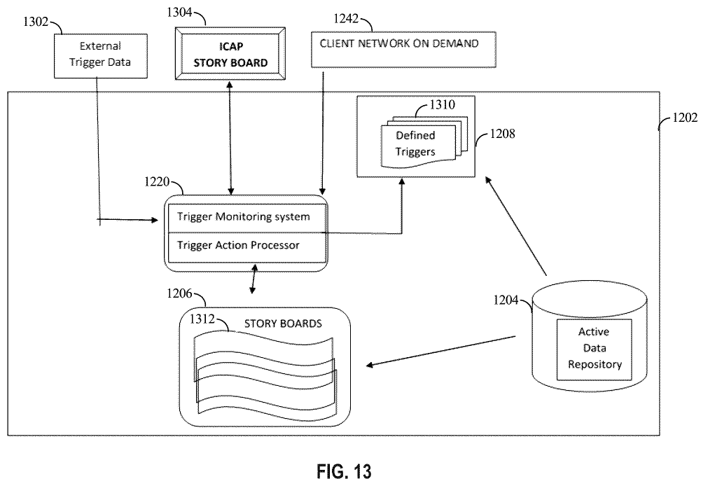

FIG. 13 provides an example flow of a trigger as processed by the platform 1200. FIG. 13 shows various components of the platform 1200, including the on demand client network 1242, an external trigger data 1302, a storyboard 1304 for one or more electronic devices, and the operation theater 1202. The operation theater 1202 shown in FIG. 13 includes the active data repository 1204, the storyboard module 1206, the external data feeds and triggers module 1208, and the manager module 1220. The storyboard module 1206 is shown having multiple storyboards, though the storyboards may be stored in the data repository 1204. The data repository 1204 may provide data to the storyboard module 1206 and/or the external data feeds and triggers module 1208 (for example, specifics of the storyboards for one or more APDs 1240 or triggers). For example, the data repository 1204 may store the storyboards and/or triggers in particular formats, as described herein. For example, the storyboard, as stored, may include an identifier for the storyboard, a type of action or message provided as part of the storyboard, one or more actions or messages provided as part of the storyboard, and one or more triggers for the one or more actions or messages of the storyboard. An example storyboard is shown below as Example Storyboard 1:

| | | | |
|---|---|---|---|
| Cheers Storyboard | Device # 1 | Event 1 | Trigger 1 |
| | | Activate Display | Contact |
| | | «cheers» on Cover | device 2 |
| | Device # 2 | Event 1 | Trigger 1 |
| | | Animate Player | Contact |
| | | On Label | device 1 |

In Example Storyboard 1, the storyboard is identified as “Cheers” and involves two devices (#1 and #2). The device #1 will perform an action of activating a display with text “Cheers” in response to the trigger of contacting another device, for example, device #2. The device #2 will perform an action of activating an animation of a sports representative on a product label in response to the trigger of contacting another device, for example, device #1. In some instances, the storyboard could include multiple other actions and/or triggers and/or devices. For example, Example Storyboard 2 includes the features of Example Storyboard 1 with additional storyboard components:

| | | | | | |
|---|---|---|---|---|---|
| Cheers 2 Storyboard | Device # 1 | Event 1 | Trigger 1 | Event 2 | Trigger 2 |
| | | Activate | Contact | . . . | |
| | | Display | device 2 | | |
| | | «cheers» | | | |
| | | on Cover | | | |
| | Device # 2 | Event 1 | Trigger 1 | Event 2 | Trigger 2 |
| | | Animate Player | Contact | . . . | |
| | | On Label | device 1 | | |
| | Device # 3 | Event 1 | Trigger 1 | Event 2 | Trigger 2 |
| | | . . . | . . . | Play | Device 2 |
| | | | | Trumpet | display player |
| | | | | Sound 3 bars | |
| | Device # 1 | Event 1 | Trigger 1 | Event | Trigger 2 |
| | | . . . | . . . | Play | Device 3 play music; |
| | | | | Guitar | delayed 1 second |
| | | | | sound 3 bars | |

In Example Storyboard 2, the storyboard is identified as “Cheers 2” and involves three devices (#1, #2, and #3). The device #1 will perform an action of activating a display with text “Cheers” in response to the trigger of contacting another device, for example, device #2. The device #2 will perform an action of activating an animation of a sports representative on a product label in response to the trigger of contacting another device, for example, device #1. The device #3 will play trumpet sounds in response to identifying that device #2 activated the player on the label. Then, the device #1 will play guitar sounds based on detection of the trumpet sounds being played and after a delay of 1 second. This information may be stored in the data repository 1204 or in a storage more local to the APDs 1240 (i.e., the device #1, device #2, and device #3) or the operation theater 1202. In some embodiments, instead of storing the entire storyboard in the electronic device 1240, the electronic device may store the triggers and/or the actions locally to know what actions to take in response to what triggers it receives. In some embodiments, the trigger for the electronic device 1240 may be receiving an input from the operation theater 1202 and the external data feeds and triggers module 1208. For example, the external data feeds and triggers module 1208 may receive inputs that it identifies as triggers, such as identifying that device #1 in the example storyboards came into contact with device #2. If one or each of the devices #1 and #2 has an impact sensor and location information, the external data feeds and triggers module 1208 may receive inputs from the impact sensors along with the location information for each of the devices and determine that the device #1 and the device #2 impacted. Thus, based on the impact and the location information, the external data feeds and triggers module 1208 may notify the device #1 and the device #2 and communicate signals that the device #1 and the device #2 will utilize as triggers for events according to the storyboard. Alternatively, the devices #1 and #2 and #3 may locally process the inputs from impact sensors and/or location information, thereby enabling the devices to identify triggers and corresponding actions without having to communicate with the operational theater 1202 for individual parts of the storyboard.

FIG. 13 shows how the data repository 1204 may provide stored information to the storyboard module 1206 and/or the external data feeds and triggers module 1208. The manager module 1220 may receive the external trigger data 1302, which corresponds with an external signal (for example, the detection of the impact from devices #1 and #2 in the Example Storyboard 1 above). The manager module 1220 may utilize one or more processes, for example, a trigger monitoring system and/or a trigger action processor that are part of the operation 1226 or control 1230 portions of the manager module 1220 to analyze and process the external trigger data. For example, the manager module 1220 may determine, based on the defined triggers 1310, whether the received external trigger data 1302 is a trigger, using the external data feeds and triggers module 1208. Additionally, the manager module 1220 may determine, based on the storyboards 1312, whether the received external trigger data 1302 that is a trigger, as identified using the external data feeds and triggers module 1208, is part of a storyboard, for example, via the storyboard module 1206. Based on a determination that the external trigger data 1302 did relate to a defined trigger 1310 that is a trigger to an action in a storyboard 1312, the manager module 1220 sends the trigger to one of the APDs 1240 that is impacted by the defined trigger 1310 and the storyboard 1312. Thus, based on the triggered event that generates the external trigger data 1302, the manager module 1220 can ensure that APDs 1240 that are part of the storyboard 1312 perform corresponding actions based on the defined trigger 1310.

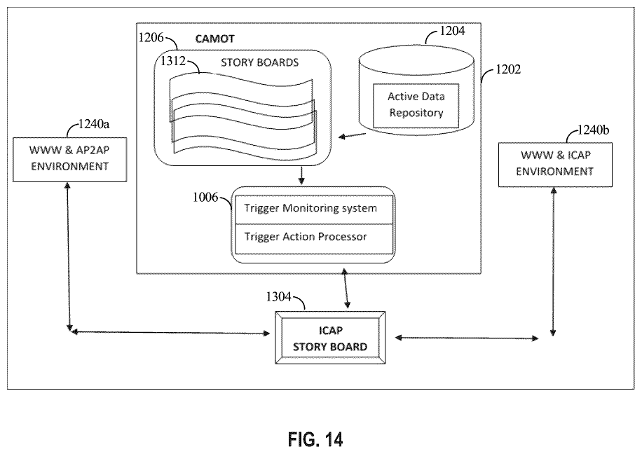

FIG. 14 provides another example flow 1400 of a trigger as processed by the platform 1200 and as it impacts the APDs 1240. The flow 1400 shows how data in the data repository 1204, as related to storyboards processed by the storyboard module 1206, can result in trigger messages being sent from the operation theater 1202 to APDs 1240 in respective environments. Accordingly, when the storyboard module 1206 identifies a trigger associated with a storyboard and the manager module 1220 identifies the trigger as having occurred (for example, based on external trigger data 1302 of FIG. 13), the manager module 1220 enables communication of the trigger to corresponding APDs 1240 that perform actions per their corresponding storyboards in their respective environments.

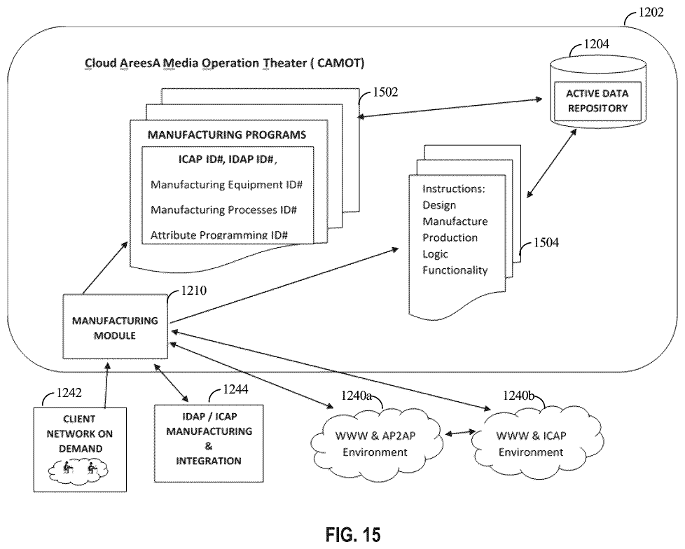

FIG. 15 shows an example flow 1500 of integrating the platform with device manufacturing processes. For example, the flow 1500 shows that manufacturing details, such as manufacturing programs 1502, can be stored in the data repository 1204. The manufacturing programs 1502 may be specific to particular APDs 1240 and/or storyboards 1312. For example, the APDs 1240 associated or integrated with a beverage can from company A may have a different manufacturing program 1502 from the electronic device 1240 associated or integrated with a beverage bottle from company A or a beverage can from company B. In some instances, the APDs 1240 integrated with different products may have similar manufacturing programs 1240. For example, cans and bottles from a same company may have similar storyboard events and triggers though. As such, the attribute programming information may be similar for the corresponding manufacturing programs 1502 while the manufacturing equipment and process identifiers may be different (for example, because different equipment or processes are used to manufacture the corresponding products.

The flow 1500 shows that the manufacturing programs 1502 can be stored in the data repository 1204 and integrated with the manufacturing module 1210. In some instances, the manufacturing module 1210 will communicate details of the manufacturing programs 1502 to corresponding manufacturing and integration devices 1244 for corresponding products with integrated APDs 1240. In some instances, the manufacturing module 1210 may communicate with existing APDs 1240 in various environments to update storyboard information for these APDs 1240. In some instances, the manufacturing and integration device 1244 may be equipment used to manufacture products and/or integrate APDs 1240 with products.

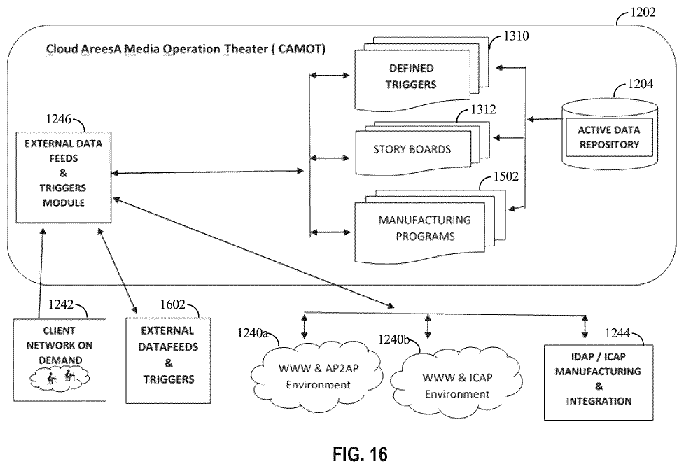

FIG. 16 shows an example flow 1600 of external data and triggers 1602 that are processed by the external data feeds and triggers module 1246. The external data feeds and triggers module 1246 may receive data inputs and/or triggers from the APDs 1240 in various environments. The external data feeds and triggers module 1246 may also comprise information from the on demand client network 1242.

The external data feeds and triggers module 1246 is shown receiving and sending data (for example, defined triggers, storyboards, and manufacturing programs) to/from the data repository 1204. Thus, via the external feeds and triggers module 1246, external data and triggers can be integrated with triggers, storyboards, and manufacturing information and/or stored in the data repository 1204.

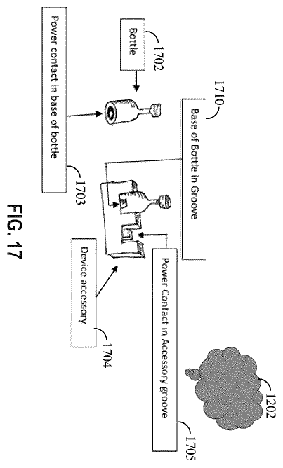

FIGS. 17-19 show examples of different products integrated with APDs 1240 and corresponding peripherals. For example, FIG. 17 shows a bottle 1702 having a device 1240 integrated therein (not shown). As shown, the bottle 1702 includes a power content 1703. The power contact 1703 allows charging of the electronic device 1240 integrated with the bottle 1702. In some instances, the power contact 1703 can also be used for communications. The bottle 1702 may be used with an accessory 1704, for example a holder or stand, that also has integrated therein another electronic device 1240. The power contacts 1703 of the bottle 1702, when placed in a position of the device accessory 1704, may contact another power contact 1705 disposed in the position of the device accessory 1704. Thus, when the bottle 1702 is placed in the groove of the device accessory 1704, as shown in FIG. 17, the bottle 1702 and the device accessory 1704 and communicate and/or operating in conjunction with each other. For example, when the bottle 1702 is a particular brand, the bottle 1702 and the device accessory 1704 may work together to display different media than either the bottle 1702 and the device accessory 1704 show individually. For example, when the bottle 1702 is placed in the device accessory 1704, the bottle 1702 may communicate with the device accessory 1704 and the two devices may display a combined message. Thus, the device accessory 1704 may be an intelligent device and power supply for the bottle 1702. The bottle 1702 can, thus, source power from the accessory device 1704 and communicate directly with the accessory device 1704. Accordingly, the bottle 1702 and the device accessory 1704 may perform events according to a storyboard such that triggers on either or both of the bottle 1702 and the device accessory 1704 can initiate events. The bottle 1702 and the device accessory 1704 may work or be integrated with the cloud-based operation theater 1202 to obtain aspects of the storyboard associated with the bottle 1902 and the device accessory 1704.

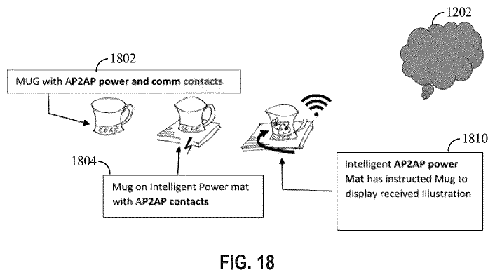

Similarly, FIG. 18 shows a mug 1802 (having power and/or communication contacts) and a device mat 1804 with corresponding contacts. When the mug 1802 is placed on the device mat 1804 so that the contacts of each are in proximity, the mug 1802 and the device mat 1804 may show the same message or share triggers. In some instances, at 1810, the device mat 1804 may receive message media from or convey message media to the mug 1802. Thus, the mug 1802 can instruct the device mat 1804 to display a message according to a corresponding storyboard or vice versa. For example, the mug 1802 may communicate a particular image (for example, a brand mark for the beverage in the mug 1802). Based on this information, the device mat 1804 may display corresponding product information, media, advertisements, and the like as part of the corresponding storyboard. The mug 1802 and the device mat 1804 may work or be integrated with the cloud-based operation theater 1202 to obtain aspects of the storyboard associated with the mug 1802 and the device mat 1804.

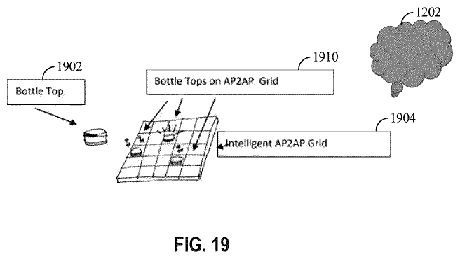

FIG. 19 shows bottle caps 1902 each having power and/or communication contacts thereon and a grid mat 1904 with corresponding contacts. When one of the bottle caps 1902 is placed on the grid mat 1904 so that the contacts of each are in proximity or touching, one of the corresponding bottle cap 1902 and the grid mat 1904 may provide a message or share triggers. For example, the bottle cap 1902 can light up, display an image or video, or play a sound or otherwise participate in a storyboard. Thus, the bottle cap 1902 or the grid mat 1904 can participate in an event according to a trigger as received from an environment and/or based on a reaction. In some instances, package components (for example, the bottle caps 1902 and the grid mat 1904) can operate either as an integral part of a larger or whole package or can be removed and operate individually with other enabled devices/accessories. The bottle cap 1902 and the grid mat 1904 may work or be integrated with the cloud-based operation theater 1202 to obtain aspects of the storyboard associated with the bottle caps 1902 and the grid mat 1904.

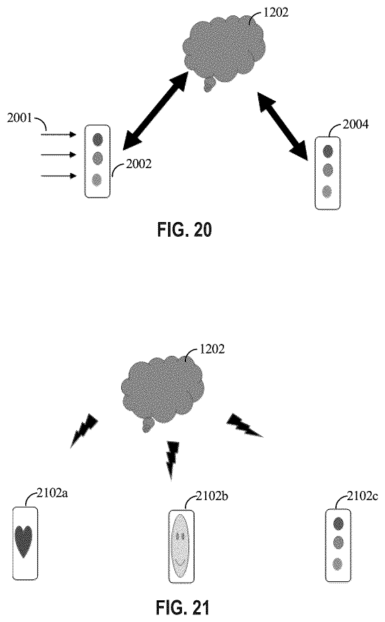

FIG. 20 shows how a user can configure an electronic device 2002 associated or integrated with a product. In some instances, as described herein, a storyboard can monitor its environment (for example, the environments of APDs 1240 involved in the storyboard). For example, if the user selects one or more features for the electronic device 2002, which is a package or accessory for a product, the user selections can be triggers for the storyboard, such that the storyboard activates or is changed, for example by the operation theater 1202. For example, if the user identifies, with inputs 2001, a particular tone, color, or graphic on the electronic device 2002, the operation theater 1202 can adapt the storyboard based on the user customization such that messaging is affiliated with, integrates, or otherwise is based on the user selections and customizations. The operation theater 1202 may communicate (via the communications module 1212) the adaptations to the storyboard back to the electronic device 2002 and any other electronic devices 2004 with which the user may interact or which may be in environments of the user. In some instances, the operation theater 1202 may update a profile or similar preferences storage for the user based on the customization such that other storyboards (existing and/or future created storyboards) with which the user interacts are automatically updated or customized based on the user selections on the electronic device 2002.

In some instances, the electronic device 2002 may be an APDs 1240 of the user (for example, a computer, a smart phone, and the like) and not be packaging or accessory associated with a product. In some instances, the user may user an app on their smart phone or similar interface (for example, web-based, and so forth) to provide the inputs 2001, which may be fed directly to the operation theater 1202.

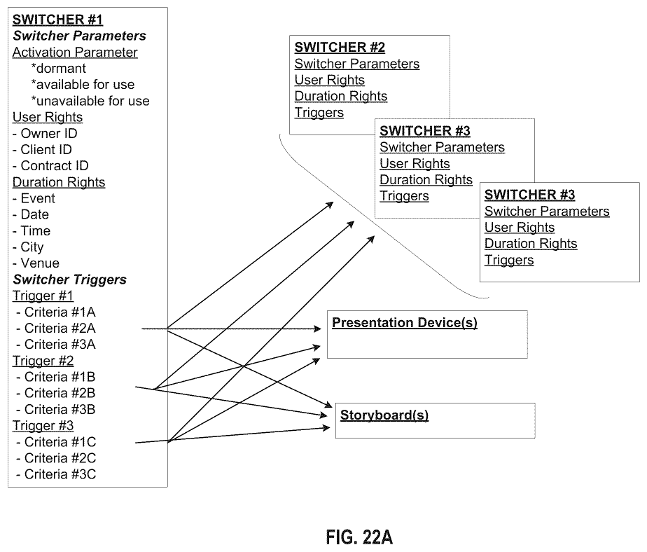

FIG. 21 shows how multiple items of the same product 2102a-2102c can each display different media or message, for example as established at manufacture. As shown, a beverage can in three locations can each be configured or programmed, according to a single or multiple storyboards, to display different features. A first can 2102a may be manufactured for sale during a holiday season and be configured, according to one or more storyboards, to display images for the holiday. For example, the first can 2102a may show a heart when configured for sale around Valentine's Day. The second can 2102b and the third can 2102c may show team logos for different teams in cities in which the cans are sold. In any of these instances, all of the cans 2102a-2102c may operate according to the same storyboard that was installed into APDs 1240 of the cans 2102a-2102c at manufacture, since the locations and time periods in which the cans 2102a-2102c are sold. The similar storyboards may each involve the same types of triggers and actions, for example play a sound or message when picked up or in proximity to moving users. In some instances, each can 2102a-2102c can be operating with individual storyboards or are customized after manufacture through communications with the operation theater 1202.

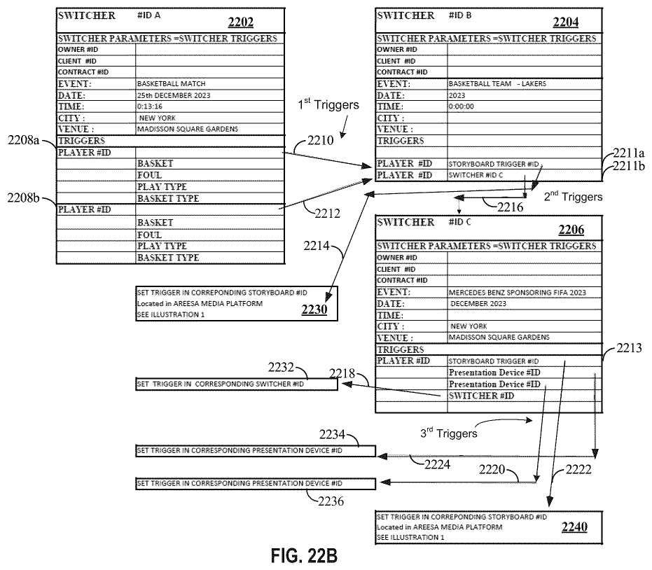

FIG. 22A illustrates an example of a general embodiment of a system that includes one or more switchers (e.g., switcher #1, switcher #2, switcher #3, switcher #4), one or more presentation device, and one or more storyboards. FIG. 22A also illustrates an example of possible communication between switcher #1 and other switchers, presentation devices, and storyboards, that can occur as result of the triggers of switcher #1 being activated.

FIG. 22B illustrates a specific example of a system that includes multiple switchers, each having multiple triggers. In FIG. 22A, switcher #1 includes switcher parameters and triggers. The Switcher parameters can include an activation parameter that indicates the state of the switcher as being either dormant, available for use, or unavailable for use. In some exemplary systems there is a single switcher (e.g., switcher #1). In other exemplary systems, there are two or more switchers. Each of the switchers is a logical construct associated with a physical or virtual event. For example, a switcher can be associated with a basketball game or other sporting event, a holiday (for example, a religious or non-religious holiday), a gala, a concert, the festival, a news event, a security event, or an emergency, a political event, and the like. The event can have one or more of an associated date, time, geographic location and/or venue. In various embodiments, the switchers illustrated in FIG. 22A may reside in a presentation device, a virtual presentation device, a dedicated switcher device, another compatible device, or in the External Datafeeds & Triggers module (see for example, FIG. 12B). The switchers can be made in the CAMOT. The switchers can be stored in the Active Data Repository (see FIG. 12B). Once one of the switchers is constructed, it be downloaded to one or more of a presentation device, a virtual presentation device, a dedicated switcher device, or a compatible device. The control and operation of a switcher, including their activation, download and connectivity) can be managed by the external data feeds & trigger module (FIG. 12B). Devices (e.g., presentation devices, virtual presentation devices, dedicated switcher devices, and compatible devices) requiring connectivity to switchers and storyboards in the CAMOT Active Data Repository by devices can be connected via the External Datafeeds & Trigger module (see, for example, FIG. 12B).

In the example illustrated in FIG. 22A, switcher #1 includes a number of switcher parameters and switcher triggers. In other examples, the switcher may have different switcher parameters. Also in other examples, the switcher may have a single trigger. In this example, the switcher parameters include an activation parameter that indicates the activation state of switcher #1 as being either dormant, available for use, or unavailable for use. The switcher parameters can also include user rights that indicate an owner, a client, and/or a contract that the switcher is associated with. In this example, the switcher parameters also include duration rights information that indicate when switcher #1 is activated. In this example, the duration rights information includes information related to a particular event, and a date, time, city, and venue that are associated with the event. In other words, the duration rights indicate when the switcher will be activated in accordance with the contract associated with the switcher. Although the duration rights in this example indicate an event, date, time, city, and venue, in other embodiments the other duration rights information can include fewer duration of rights (e.g., just a date), additional duration of rights, or different duration of rights to define the circumstances in which the switcher should be activated. In this example, switcher #1 includes three triggers, each trigger having a plurality of criteria that causes the trigger to activate in provide communication signal (e.g., an activation signal) to one or more other switchers, one or more presentation devices, and/or one or more storyboards. The criteria for each trigger can relate to an occurrence of something at the event. For example, scoring of a goal at a soccer match. The switcher may receive information that the occurrence happened based on receiving a signal from a system that is sensed that the occurrence is happened (e.g., sensed by a device at the event) or from a system that is communicating information that the occurrences happen (a network of online feed). When the switcher is available for use and all of the parameters and trigger criteria have been met, the trigger provides an activation signal to one or more other switchers, one or more presentation devices, and/or one or more storyboards, and these systems can act on the received activation signal based on the configuration, as described herein. In other words, each trigger is associated with a defined sensed action or occurrence of an event that activates the trigger, such that when the “triggering” action occurs, the trigger activates. The triggering actions are defined and presented or encoded in a format to be recognizable by the trigger. A trigger may also be “manually” activated, e.g., with a user input. Examples of such action include, but are not limited to, a mechanical action, an analog or digital action (signal), a communication, a physical action, a natural action, movement, sound, light, a sight (e.g., a sign, braille, sign language, etc.). In an example, a trigger is defined to activate based on a certain sound. If the certain sound is sensed and interpreted as being the defined sound, the certain sound becomes a triggering event for that trigger and the trigger activates. Triggers have parameters that can be set and modified by a person/system having the required authorization. Each trigger includes a unique identification (e.g., numbers, characters, and/or symbols). The ID can be indicative of data associated with the trigger and the switcher with which it is associated. each trigger can contain information (e.g., data and parameters) defining the trigger's response when it is activated. In one example, when a trigger is activated it can initiate communication, and communicate data, time dependencies, and one or more target ID's for receipt of the information related to the trigger. This information can be contained in the switcher with trigger authorization rights and other authorization rights pertaining to target ID's for receipt of the information related to the trigger. Target ID's can be associated with presentation device ID's as well as with corresponding trigger ID's.

FIG. 22B illustrates an example of a system that includes multiple switchers 2202, 2204, 2206 that are configured to communicate to provide a storyboard. Each switcher has parameters/data which are defined when generated and which may be modified. A client contract associated with a client contract ID #defines to which switchers a client may have access to, what functionality (copy download, modify, and the like), and which parameters in the switcher and its content data the client can modify, and which triggers in the switcher the client can access/use/connect to/associate with. As described further below in reference to FIG. 22B, the player #ID is part of the construct of the associated switcher and part of the functionality of the switcher. The trigger will be identifiable by the External Data Feeds & Trigger functionality/system (e.g., 1246 in FIG. 12B) or by the logical mechanism in the pertinent device (e.g., presentation device). The trigger will initiate one or more subsequent actions associated with the trigger. The trigger status (on/off), actions (e.g., trigger content, signals it sends) and definition of when it “triggers” can be modified if a user or entity has the control rights to do so. The External Data Feeds & Trigger functionality/system are responsible for management and control of the operation of the triggers, and can monitor and record its “triggering” actions. For example, a target switcher #ID and the pertinent triggers that are setup of the target switcher #ID, the target storyboard #ID and the pertinent triggers setup in that target storyboard #ID, and/or the target presentation device and the pertinent triggers setup in that target presentation #ID.

A switcher has a certain duration of rights that dictate when the switcher is in use. The duration of rights is defined and set up in an associated client contract for certain dates and times when the client will be able to access and use the associated switcher. For example, the switcher can have event parameter that is defined for a certain date, time, geographic location, and venue that indicate when the switcher is active. These parameters determined when a switcher is constructed. The can be modified via the external data feeds and triggers module 1246. In the modification process (before their active), the switchers can be unavailable for use or any dormant mode. In a case where a client has been granted access or modification rights to a certain switcher, the client could set triggers to activate the client's associated switcher or another switcher that also has certain client access or modification rights, and which would have local internal parameters in triggers including that of an event with a certain date, time, geographic location, and venue. In addition to clients access restrictions and rights as per the relevant client contract, any switcher can be configured to override or limit access of a client subsequent switcher storyboard or device.

The external data feeds and triggers functionality 1246 will maintain a real-time trace of access and use of switchers and triggers with relevant details (e.g., when, what, associated clients, devices, switchers, storyboards, modifications, use, activation of triggers, etc.). As mentioned above, each switcher has a unique ID which is set up during the switcher construction/configuration. In an example, as shown in FIG. 22, the player #ID is part of a trigger, which is part of the construct of a switcher and function of the switcher A 2202. That trigger when set as a result of itself, or any of the subsequent parameters data associated with that trigger in switcher A 2202 will be identified by the external data feeds and triggers functionality 1246, or by the logical mechanism in the pertinent device, which will initiate a sequence of subsequent actions associated with the associated. The switchers can be defined and configured by users and systems. Such a system allows users and system scope to collaborate, where a switcher is able to be used, integrated, or connected to form a configuration of multiple switches operate.

In this example, Switcher A 2202 includes parameters relating to a basketball match, at a certain date (Dec. 25, 2023), time (9:13:16), city (New York), and venue ((Madison Square Gardens). It also includes two first triggers 2208, each trigger relating to a different certain player, and certain events for the player during the game (e.g., basket, fall, play type, basket type). When the parameters of Switcher A 2202 are met (i.e., that particular game is being played), one or more of the triggers 2208 may be activated when, for example, the player associated with the trigger makes a basket, commits of file, is involved in a certain type of play, or makes a certain type of basket. When a first trigger 2208 is activated, a communication 2210, 2212 is provided to Switcher B 2204.

Switcher B 2204 also includes parameters relating to a basketball team, in this case, the Los Angeles Lakers. Switcher B 2204 also includes two “second” triggers 2211a,b that are associated with the same players as the triggers 2208a,b. The communication 2210 from trigger 2208a to trigger 2211a causes trigger 2211a to activate, and provides a communication 2214 to the AREESA Media Platform in block 2230, which sets the trigger in a corresponding storyboard. The communication 2212 from trigger 2208b to trigger 2211b causes trigger 2211b to activate and send communication 2216 to Switcher C 2206.

In this example, Switcher C 2206 includes parameters relating to a certain company (Mercedes Benz) sponsoring an event (FIFA 2023) on a certain event date (December 2023), in a city (New York), at a venue (Madison Square Gardens). Switcher C 2206 is also configured with a trigger 2213. When trigger 2213 activates, it provides a communication 2222 to set/activate a trigger in a corresponding storyboard located in the AREESA Media Platform as shown in block 2240. When trigger 2213 activates, it also provides communication 2224 to set/activate a trigger of a presentation device having a certain device ID, as shown in block 2234; the presentation device may then provide an SDES based on its configuration. When trigger 2213 activates, it further provides a communication 2220 to activate a trigger in another designated presentation device having a certain ID, as shown in block 2236; the presentation device may then provide an SDES based on its configuration. When trigger 2213 activates, it also provides a communication 2222 to set/activate a trigger in the corresponding storyboard with a certain ID located in an AREESA Media Platform. In an example, the presentation devices which are activated can be included on consumer products, and/or they can be larger presentation devices in a location where multiple viewers can see the presentation. For example, in Madison Square Gardens, on vehicles, billboards, or any other type presentation device.

In this example, Switcher A 2202, Switcher B 2204, and Switcher C 2206, and the presentation devices which they are in communication with, operate as a synchronized system to provide the presentation of a storyboard under certain circumstances. For example, when a certain player on the Los Angeles Lakers basketball team makes a basket, the certain presentation relating to Mercedes-Benz sponsoring of the by 2023 is presented by one or more presentation devices to a plurality of viewers.

In some instances, the storyboard could include multiple other actions and/or triggers and/or devices. multiple Although described separately, it is to be appreciated that functional blocks described with respect to FIGS. 1-22 need not be separate structural elements. For example, the functional blocks may be embodied on a single chip or within a single controller. Similarly, one or more of the functional blocks or portions of the functionality of various blocks may be embodied on a single chip or a single controller. Alternatively, the functionality of a particular block may be implemented on two or more chips.

One or more of the functional blocks and/or one or more combinations of the functional blocks may be embodied as a general purpose processor, a digital signal processor (DSP), an application specific integrated device, discrete gate or transistor logic, discrete hardware components, circuitry or any suitable combination thereof designed to perform the functions described herein. In this specification and the appended claims, it should be clear that the term “circuitry” is construed as a structural term and not as a functional term. For example, circuitry may be an aggregate of circuit components, such as a multiplicity of integrated circuit components, in the form of processing and/or memory cells, units, blocks, and the like, such as shown and described in the Figures. One or more of the functional blocks and/or one or more combinations of the functional blocks described may also be implemented as a combination of computing devices, e.g., a combination of a DSP and a microprocessor, a plurality of microprocessors, one or more microprocessor in conjunction with a DSP communication, or any other such implementation.

If implemented in software, the functions may be stored on or transmitted over as one or more instructions or code on a computer-readable medium. The steps of a method or algorithm disclosed herein may be implemented in a processor-executable software module that may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium that may be incorporated into a computer program product.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may include one or more elements.

A person/one having ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

A person/one having ordinary skill in the art would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, that may be designed using source coding or some other technique), various forms of program or design code incorporating instructions (that may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein and in connection with FIGS. 1-11 may be implemented within or performed by an integrated circuit (IC), an access terminal, or an access point. The IC may include a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. The logical blocks, modules, and circuits may include antennas and/or transceivers to communicate with various components within the network or within the device. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such implementation. The functionality of the modules may be implemented in some other manner as taught herein. The functionality described herein (e.g., with regard to one or more of the accompanying figures) may correspond in some aspects to similarly designated “means for” functionality in the appended claims.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Certain features that are described in this specification in the context of separate implementations also may be implemented in combination in a single implementation. Conversely, various features that are described in the context of a single implementation also may be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, other implementations are within the scope of the following claims. In some cases, the actions recited in the claims may be performed in a different order and still achieve desirable results.

What is claimed is:

1. A method for providing a presentation on a plurality of presentation devices using a storyboard system configured to generate a storyboard based on types and capabilities of presentation devices that are detected as being in communication with the system, the storyboard allowing for dynamic storylines that can trigger a device action based on a detected condition, the method comprising:
detecting presentation devices in communication with the storyboard system;
generating by the storyboard system a storyboard that allows for dynamic storylines that are adapted in real time based on the detected presentation devices and based on detection of a condition;
generating data items corresponding to the storyboard and storing the data items in a database of the storyboard system, the data items defining a synchronized set of actions to be performed on the presentation devices based on detected conditions, at least a portion of the data items including time synchronization information for the set of actions;
receive information at the storyboard system of a detected condition that triggers an action of the storyboard;
determining a set of actions from a storyline of the storyboard, wherein the set of actions are based on the detected condition; and
communicating data items related to the detected condition and defining the determined set of actions from the database of the storyboard system to the presentation devices,
wherein the method is performed by one or more computer hardware processors configured to execute computer-executable instructions on one or more non-transitory computer storage mediums.

2. The method of claim 1, wherein the detected condition is a geographic location.

3. The method of claim 1, wherein the presentation devices comprises one or more groups of presentation devices.

4. The method of claim 3, and wherein each group of presentation devices has a common unique group identifier.

5. The method of claim 3, wherein the presentation devices include one or more of a television, radio, personal computer, video wall, smartphone, tablet computer, a billboard, wall display, an electronic display device, a mechanical robotic or display device, or product packaging.

6. The method of claim 1, further comprising receiving data information from an external source, wherein generating data items comprising generating data items using the data information.

7. The method of claim 6, wherein the data information includes video data.

8. The method of claim 7, wherein the data information includes real-time video data.

9. The method of claim 1, further comprising
activating a first switcher in communication with the storyboard system;
receiving, at a first switcher, event information indicative of the occurrence of an action of a particular event;
determining if the event information meets triggering criteria for a trigger of the first switcher; and
in response to the event information meeting triggering criteria for a trigger of the first switcher, activating the trigger of the first switcher that meets the triggering criteria, wherein activating the trigger of the first switcher includes sending, by the first switcher, a state of desired effect (SDES) activation signal to a first set of presentation devices identified by the trigger identification code of the activated trigger, and providing by the first set of presentation devices a SDES based on the SDES activation signal.

10. The method of claim 9, wherein the method further comprises sending, by the first switcher, a trigger activation signal to a second switcher identified by the trigger identification code, and activating a trigger of the second switcher if the activation parameters of the second switcher are met.

11. The method of claim 10, wherein activating the trigger of the second switcher includes sending an SDES activation signal to a second set of presentation devices or sending a trigger activation signal to a third switcher.

12. The method of claim 9, wherein activating the first switcher comprises determining that the activation parameters of the first switcher have been meet.

13. The method of claim 9, wherein providing the SDES activation signal to a first set of presentation devices comprises non-simultaneously providing the SDES activation signal to the first set of presentation devices.

14. The method of claim 9, wherein providing the SDES activation signal to a first set of presentation devices comprises providing the SDES activation signal to a plurality of presentation devices in a predetermined order.

15. The method of claim 9, wherein the first set of presentation devices includes product packaging coupled to a product.

16. The method of claim 9, wherein product packaging houses at least a portion of the product.

17. The method of claim 9, wherein product packaging comprises material used for holding, and transporting the product.

18. The method of claim 9, wherein receiving event information comprises receiving event information from a computer system communicating information relating to an event.

19. The method of claim 9, wherein the event information comprises information relating to a sporting event.

20. The method of claim 9, wherein the event information comprises information related to a political event, a promotional event, or an environmental event.
